(19) United States
(12) Patent Application Publication
(10) Pub. No.: US 2012/0176356 A1
(43) Pub. Date: Jul. 12, 2012

(54) DISPLAY DEVICE

(75) Inventors: Naru Usukura, Osaka (JP); Hiromi Katoh, Osaka (JP); Yasuhiro Sugita, Osaka (JP); Kohhei Tanaka, Osaka (JP); Kaoru Yamamoto, Osaka (JP); Christopher Brown, Osaka (JP)

(73) Assignee: SHARP KABUSHIKI KAISHA, Osaka-shi, Osaka (JP)

(21) Appl. No.: 13/497,358

(22) PCT Filed: Jun. 8, 2010
(86) PCT No.: PCT/JP10/59682

§ 371 Date: Mar. 21, 2012

(30) Foreign Application Priority Data
Sep. 30, 2009 (JP) 2009-226563

(51) Int. Cl. G09G 5/00

(52) U.S. Cl. 345/207

(57) ABSTRACT

A plurality of sensor pixel circuits are disclosed for detecting a difference between an amount of light when a backlight is turned on and an amount of light when the backlight is turned off are arranged in a pixel region. The backlight is turned on and off a plurality of times, respectively, in a one-frame period. Each of reset for the sensor pixel circuits and read from the sensor pixel circuits is performed in parallel, each in a line sequential manner over almost the one-frame period. A plurality of sensor pixel circuits of two types for separately detecting an amount of light when the backlight is turned on and an amount of light when the backlight is turned off may be arranged in the pixel region, and a difference circuit may be used for obtaining a difference between the two types of amounts of light.

### TECHNICAL FIELD

The present invention relates to display devices, and more particularly to a display device in which a plurality of optical sensors are arranged in a pixel region.

### BACKGROUND ART

With regard to display devices, heretofore, there have been known methods of providing input functions such as touch panels, pen input and scanners in such a manner that a plurality of optical sensors are provided on a display panel. In order to adapt such a method to a mobile appliance to be used under various light environments, it is necessary to eliminate an influence of the light environment. Therefore, there has also been known a method of removing a component depending on a light environment from a signal sensed by an optical sensor to obtain a signal to be input intrinsically.

Patent Document 1 describes an input/output device in which light receiving elements are provided corresponding to individual displaying elements. In the input/output device, a backlight is turned on and off once in a one-frame period, and reset for and read from the light receiving elements are performed in a line sequential manner so that an amount of light during a backlight turn-on period and an amount of light during a backlight turn-off period are obtained from all the light receiving elements in the one-frame period.

FIG. 44 is a diagram showing turn-on and turn-off timings of the backlight as well as reset and read timings of the light receiving elements, in Patent Document 1. As shown in FIG. 44, in the one-frame period, the backlight is turned on in the former half and is turned off in the latter half. During the backlight turn-on period, the reset for the light receiving elements is performed in a line sequential manner (a solid line arrow), and then the read from the light receiving elements is performed in a line sequential manner (a broken line arrow). Also during the backlight turn-off period, the reset for and read from the light receiving elements are performed in the similar manner.

Patent Document 2 describes a solid-state imaging device including a unit light receiving section shown in FIG. 45. As shown in FIG. 45, the unit light receiving section includes one photoelectric converting part PD, and two charge accumulating parts C1 and C2. In the case of receiving both external light and light which is emitted from light emitting means and then is reflected from a physical object, a first sample gate SG1 turns on, and charge generated by the photoelectric converting part PD is accumulated in the first charge accumulating part C1. In the case of receiving only external light, a second sample gate SG2 turns on, and the charge generated by the photoelectric converting part PD is accumulated in the second charge accumulating part C2. It is possible to obtain a difference between the amounts of charge accumulated in the two charge accumulating parts C1 and C2, thereby obtaining an amount of light which is emitted from the light emitting means and then is reflected from the physical object.

### PRIOR ART DOCUMENTS

### Patent Documents

Patent Document 1: Japanese Patent No. 4072732

Patent Document 2: Japanese Patent No. 3521187

### SUMMARY OF THE INVENTION

### Problems to be Solved by the Invention

In a typical display device in which a plurality of optical sensors are provided on a display panel, read from the optical sensors is performed in a line sequential manner.

Moreover, backlights for a mobile appliance are turned on simultaneously and are turned off simultaneously as an entire screen.

In the input/output device described in Patent Document 1, the backlight is turned on and off once in the one-frame period. During the backlight turn-on period, a period for the reset does not overlap with a period for the read. Also during the backlight turn-off period, a period for the reset does not overlap with a period for the read. Consequently, the read from the light receiving elements needs to be performed within a 1/4-frame period (for example, within 1/240 seconds in the case where a frame rate is 60 frames per second). In an actual fact, however, it is considerably difficult to perform the high-speed read described above.

Moreover, there is a deviation corresponding to a 1/2-frame period between a period (B1 shown in FIG. 44) during which the light receiving element senses light in the backlight turn-on period and a period (B2 shown in FIG. 44) during which the light receiving element senses light in the backlight turn-off period. Consequently, followability to motion input varies in accordance with a direction of the input. Moreover, this input/output device starts to perform the read immediately after completion of the reset, and starts to perform the reset immediately after completion of the read. Consequently, it is impossible to freely set a length and an interval with regard to the backlight turn-on period and the backlight turn-off period.

Hence, it is an object of the present invention to provide a display device that solves the problems described above, and has an input function which does not depend on light environments.

### Means for Solving the Problems

According to a first aspect of the present invention, there is provided a display device in which a plurality of optical sensors are arranged in a pixel region, the display device including: a display panel that includes a plurality of display pixel circuits and a plurality of sensor pixel circuits; a light source that is turned on and off a plurality of times, respectively, in a one-frame period; and a drive circuit that outputs, to the sensor pixel circuits, a control signal indicating that a light source is turned on or the light source is turned off, and performs reset for and read from the sensor pixel circuits, wherein the sensor pixel circuit performs an operation for detecting a difference between an amount of light when the light source is turned on and an amount of light when the light source is turned off, in accordance with the control signal, and the drive circuit performs the reset for the sensor pixel circuits and the read from the sensor pixel circuits in parallel, each in a line sequential manner.

According to a second aspect of the present invention, in the first aspect of the present invention, the drive circuit performs the reset for the sensor pixel circuits and the read from the sensor pixel circuits once, respectively, in the one-frame period over almost the one-frame period.

According to a third aspect of the present invention, in the second aspect of the present invention, the drive circuit performs the read from the sensor pixel circuits on one row, and then immediately performs the reset for the sensor pixel circuits on the row.

According to a fourth aspect of the present invention, in the third aspect of the present invention, a turn-on period of the light source is equal in length to a turn-off period of the light source.

According to a fifth aspect of the present invention, in the first aspect of the present invention, the sensor pixel circuit includes: a first optical sensor; a second optical sensor; one accumulation node accumulating charge corresponding to an amount of sensed light; and a read transistor having a control terminal connected to the accumulation node, and the sensor pixel circuit is configured so that, in accordance with the control signal, a potential at the accumulation node is changed in a predetermined direction by a current flowing through the first optical sensor when the light source is turned on and is changed in the reverse direction by a current flowing through the second optical sensor when the light source is turned off.

According to a sixth aspect of the present invention, in the fifth aspect of the present invention, the sensor pixel circuit further includes: a first switching element that is provided on a path for the current flowing through the first optical sensor and turns on, in accordance with the control signal, when the light source is turned on; and a second switching element that is provided on a path for the current flowing through the second optical sensor and turns on, in accordance with the control signal, when the light source is turned off.

According to a seventh aspect of the present invention, in the fifth aspect of the present invention, the first and second optical sensors have sensitivity characteristics that, in accordance with the control signal, the current flowing through the first optical sensor becomes larger in amount than the current flowing through the second optical sensor when the light source is turned on, and the current flowing through the second optical sensor becomes larger in amount than the current flowing through the first optical sensor when the light source is turned off.

According to an eighth aspect of the present invention, in the first aspect of the present invention, the sensor pixel circuit includes: one optical sensor; one accumulation node accumulating charge corresponding to an amount of sensed light; a read transistor having a control terminal connected to the accumulation node; and a plurality of switching elements that turn on or off in accordance with the control signal and switch a path for a current flowing through the optical sensor, and the sensor pixel circuit is configured so that, in accordance with the control signal, the current flowing through the optical sensor flows in a predetermined direction with respect to the accumulation node when the light source is turned on, and flows in the reverse direction with respect to the accumulation node when the light source is turned off.

According to a ninth aspect of the present invention, in the eighth aspect of the present invention, the sensor pixel circuit includes: a first switching element that is provided between a reset line and one of ends of the optical sensor and turns on when the light source is turned on; a second switching element that is provided between a wire applied with a predetermined potential and the other end of the optical sensor and turns on when the light source is turned off; a third switching element that is provided between the accumulation node and the one of ends of the optical sensor and turns on when the light source is turned off; and a fourth switching element that is provided between the accumulation node and the other end of the optical sensor and turns on when the light source is turned on.

According to a tenth aspect of the present invention, in the first aspect of the present invention, the sensor pixel circuits include: a first sensor pixel circuit that senses light when the light source is turned on and retains the amount of sensed light otherwise, in accordance with the control signal; and a second sensor pixel circuit that senses light when the light source is turned off and retains the amount of sensed light otherwise, in accordance with the control signal.

According to an eleventh aspect of the present invention, in the tenth aspect of the present invention, each of the first and second sensor pixel circuits includes: one optical sensor; one accumulation node accumulating charge corresponding to the amount of sensed light; a read transistor having a control terminal being electrically connectable to the accumulation node; and a retention switching element that is provided on a path for a current flowing through the optical sensor and turns on or off in accordance with the control signal, the retention switching element included in the first sensor pixel circuit turns on when the light source is turned on, and the retention switching element included in the second sensor pixel circuit turns on when the light source is turned off.

According to a twelfth aspect of the present invention, in the tenth aspect of the present invention, the display panel further includes a plurality of output lines for propagating output signals from the first and second sensor pixel circuits, the first and second sensor pixel circuits are connected to the different output lines depending on the type, and the drive circuit performs the read from the first and second sensor pixel circuits in parallel.

According to a thirteenth aspect of the present invention, in the twelfth aspect of the present invention, the display device further includes a difference circuit that obtains a difference between the output signal from the first sensor pixel circuit and the output signal from the second sensor pixel circuit.

According to a fourteenth aspect of the present invention, there is provided a method for driving a display device having a display panel that includes a plurality of display pixel circuits and a plurality of sensor pixel circuits, and a light source, the method including the steps of: turning the light source on and off a plurality of times, respectively, in a one-frame period; outputting, to the sensor pixel circuits, a control signal indicating that the light source is turned on or the light source is turned off; performing an operation for detecting a difference between an amount of light when the light source is turned on and an amount of light when the light source is turned off, in accordance with the control signal, by use of the sensor pixel circuits; performing reset for the sensor pixel circuits in a line sequential manner; and performing read from the sensor pixel circuits in a line sequential manner in parallel to the reset.

### Effects of the Invention

According to the first or fourteenth aspect of the present invention, the light source is turned on and off a plurality of times, respectively, in the one-frame period, and the sensor pixel circuit performs the operation for detecting the difference between the amount of light when the light source is turned on and the amount of light when the light source is turned off. Herein, one sensor pixel circuit may detect the difference between the two types of amounts of light. Alternatively, the sensor pixel circuits may include one that detects one of the amounts of light, and one that detects the other amount of light. In any of the configurations, it is possible to detect the difference between the amount of light when the light source is turned on and the amount of light when the light source is turned off, and to provide an input function which does not depend on light environments. Moreover, as compared with the case of detecting two types of amounts of light sequentially by use of one sensor pixel circuit, it is possible to reduce a frequency of the read from the sensor pixel circuits, to retard the read speed, and to reduce power consumption in the device. Moreover, it becomes unnecessary to provide a memory which is required in the case of detecting two types of amounts of light sequentially and is used for storing the amount of light sensed firstly. Moreover, by performing the reset for the sensor pixel circuits and the read from the sensor pixel circuits in parallel, each in a line sequential manner, it is possible to increase the degree of freedom for setting the turn-on and turn-off timings of the light source as well as the reset and read timings of the sensor pixel circuits, and to retard the reset speed and the read speed. Moreover, by performing the operation of sensing light when the light source is turned on and the operation of sensing light when the light source is turned off a plurality of times, respectively, in the one-frame period, it is possible to eliminate a deviation between the sensing period when the light source is turned on and the sensing period when the light source is turned off, and to prevent followability to motion input from varying in accordance with a direction of the input.

According to the second aspect of the present invention, by performing the reset for the sensor pixel circuits and the read from the sensor pixel circuits in parallel over the one-frame period, it is possible to retard the reset speed and the read speed.

According to the third aspect of the present invention, by performing the read from the sensor pixel circuits on one row, and then immediately perform the reset for the sensor pixel circuits on the row, it is possible to set a period, during which the sensor pixel circuit senses light, at almost the one-frame period.

According to the fourth aspect of the present invention, by detecting the amount of light when the light source is turned on and the amount of light when the light source is turned off, in the periods which are equal in length to each other, it is possible to accurately obtain the difference between the amount of light when the light source is turned on and the amount of light when the light source is turned off.

According to the fifth aspect of the present invention, the sensor pixel circuit includes the two optical sensors and the one accumulation node, and the potential at the accumulation node changes in reverse direction when the light source is turned on and when the light source is turned off. Accordingly, it is possible to detect a difference between an amount of light when the light source is turned on and an amount of light when the light source is turned off, by use of one sensor pixel circuit, and to provide an input function which does not depend on light environments. Moreover, the difference between the amounts of light is detected by use of one sensor pixel circuit. As compared with the case of detecting two types of amounts of light separately, therefore, it is possible to prevent the amount of light from being saturated, to correctly obtain the difference between the amounts of light, and to perform temperature compensation.

According to the sixth aspect of the present invention, when the light source is turned on, the first switching element turns on, so that the current flows through the first optical sensor. When the light source is turned off, the second switching element turns on, so that the current flows through the second optical sensor. Accordingly, by setting a potential at the reset line and the predetermined potential appropriately, it is possible to constitute the sensor pixel circuit in which the potential at an accumulation node changes in reverse direction when the light source is turned on and when the light source is turned off and which is allowed to detect the difference between the amount of light when the light source is turned on and the amount of light when the light source is turned off.

According to the seventh aspect of the present invention, a relation in amount between the currents flowing through the two optical sensors differs when the light source is turned on and when the light source is turned off. Accordingly, by setting the potential at the reset line and the predetermined potential appropriately, it is possible to constitute the sensor pixel circuit in which the potential at the accumulation node changes in reverse direction when the light source is turned on and when the light source is turned off and which is allowed to detect the difference between the amount of light when the light source is turned on and the amount of light when the light source is turned off.

According to the eighth aspect of the present invention, the sensor pixel circuit includes the one optical sensor and the one accumulation node. Moreover, the current flows from/into the accumulation node in reverse direction and a potential at the accumulation node changes in reverse direction when the light source is turned on and when the light source is turned off. Accordingly, it is possible to detect a difference between an amount of light when the light source is turned on and an amount of light when the light source is turned off, by use of one sensor pixel circuit, and to provide an input function which does not depend on light environments. Moreover, the difference between the amounts of light is detected by use of one sensor pixel circuit. As compared with the case of detecting two types of amounts of light separately, therefore, it is possible to prevent the amount of light from being saturated, to correctly obtain the difference between the amounts of light, and to perform temperature compensation.

According to the ninth aspect of the present invention, when the light source is turned on, the first and fourth switching elements turn on, and a current path is formed to pass through the optical sensor and the first and fourth switching elements. When the light source is turned off, the second and third switching elements turn on, and a current path is formed to pass through the optical sensor and the second and third switching elements. Accordingly, by setting a potential at the reset line and the predetermined potential appropriately, it is possible to constitute the sensor pixel circuit in which the current flows from/into the accumulation node in reverse direction when the light source is turned on and when the light source is turned off and which is allowed to detect the difference between the amount of light when the light source is turned on and the amount of light when the light source is turned off.

According to the tenth aspect of the present invention, it is possible to detect the amount of light when the light source is turned on and the amount of light when the light source is turned off separately by use of the sensor pixel circuits of two types, and to obtain the difference between the two amounts of light at the outside of the sensor pixel circuit. Thus, it is possible to provide an input function which does not depend on light environments. Moreover, by obtaining a difference between dark currents at the outside of the sensor pixel circuit, it is possible to perform temperature compensation.

According to the eleventh aspect of the present invention, the retention switching element that turns on during the designated sensing period is provided on the path for the current flowing through the optical sensor. Thus, it is possible to constitute the first sensor pixel circuit that senses light when the light source is turned on and retains the amount of sensed light otherwise, and the second sensor pixel circuit that senses light when the light source is turned off and retains the amount of sensed light otherwise. It is possible to obtain the difference between the amount of light when the light source is turned on and the amount of light when the light source is turned off, at the outside of the sensor pixel circuits, based on the output signals from these sensor pixel circuits.

According to the twelfth aspect of the present invention, by connecting the first and second sensor pixel circuits to the different output lines depending on the type and performing the read from the sensor pixel circuits of two types in parallel, it is possible to retard the read speed and reducing power consumption in the device. Moreover, in case of reading the two types of amounts of light in parallel and then immediately obtaining the difference between the two amounts of light, it becomes unnecessary to provide a memory which is required in the case of detecting two types of amounts of light sequentially and is used for storing the amount of light sensed firstly.

According to the thirteenth aspect of the present invention, by providing the difference circuit that obtains the difference between the output signal from the first sensor pixel circuit and the output signal from the second sensor pixel circuit, it is possible to immediately obtain the difference between the amount of light to be incident when the light source is turned on and the amount of light to be incident when the light source is turned off, and to eliminate the need for a memory that stores the amount of light sensed firstly.

### BRIEF DESCRIPTION OF THE DRAWINGS

FIG. 1 is a block diagram showing a configuration of a display device according to one embodiment of the present invention.

FIG. 2A is a diagram showing a first example of an arrangement of sensor pixel circuits on a display panel included in the display device shown in FIG. 1.

FIG. 2B is a diagram showing a second example of the arrangement of the sensor pixel circuits on the display panel included in the display device shown in FIG. 1.

FIG. 3 is a diagram showing turn-on and turn-off timings of a backlight as well as reset and read timings of the sensor pixel circuits, in the display device shown in FIG. 1.

FIG. 4A is a signal waveform diagram of the first example for the display panel included in the display device shown in FIG. 1.

FIG. 4B is a signal waveform diagram of the second example for the display panel included in the display device shown in FIG. 1.

FIG. 5A is a diagram showing a schematic configuration of a sensor pixel circuit which is included in the display device shown in FIG. 1 and has a first configuration.

FIG. 5B is a diagram showing a schematic configuration of a sensor pixel circuit which is included in the display device shown in FIG. 1 and has a second configuration.

FIG. 5C is a diagram showing schematic configurations of sensor pixel circuits each of which is included in the display device shown in FIG. 1 and has a third configuration.

FIG. 6 is a circuit diagram of a sensor pixel circuit according to a first embodiment of the present invention.

FIG. 7 is a diagram showing operations of the sensor pixel circuit shown in FIG. 6.

FIG. 8 is a signal waveform diagram of the sensor pixel circuit shown in FIG. 6.

FIG. 9 is a circuit diagram of a sensor pixel circuit according to a second embodiment of the present invention.

FIG. 10 is a diagram showing operations of the sensor pixel circuit shown in FIG. 9.

FIG. 11 is a circuit diagram of a sensor pixel circuit according to a third embodiment of the present invention.

FIG. 12 is a diagram showing operations of the sensor pixel circuit shown in FIG. 11.

FIG. 13 is a circuit diagram of a sensor pixel circuit according to a fourth embodiment of the present invention.

FIG. 14A is a layout diagram of the sensor pixel circuit shown in FIG. 13.

FIG. 14B is another layout diagram of the sensor pixel circuit shown in FIG. 13.

FIG. 15 is a diagram showing a situation that a state of a photodiode changes in accordance with a potential at a light shielding film.

FIG. 16 is a diagram showing a relation between the potential at the light shielding film and currents flowing through the photodiode.

FIG. 17 is a diagram showing sensitivity characteristics of the photodiodes included in the sensor pixel circuit shown in FIG. 13.

FIG. 18 is a diagram showing operations of the sensor pixel circuit shown in FIG. 13.

FIG. 19 is a circuit diagram of a sensor pixel circuit according to a fifth embodiment of the present invention.

FIG. 20A is a layout diagram of the sensor pixel circuit shown in FIG. 19.

FIG. 20B is another layout diagram of the sensor pixel circuit shown in FIG. 19.

FIG. 21A is a circuit diagram of a pixel circuit according to a modification example of the fourth embodiment.

FIG. 21B is a circuit diagram of a pixel circuit according to a modification example of the fifth embodiment.

FIG. 22 is a diagram showing sensitivity characteristics of photodiodes included in each of the sensor pixel circuits shown in FIGS. 21A and 21B.

FIG. 23 is a circuit diagram of a sensor pixel circuit according to a sixth embodiment of the present invention.

FIG. 24 is a diagram showing operations of the sensor pixel circuit shown in FIG. 23.

FIG. 25 is a signal waveform diagram of the sensor pixel circuit shown in FIG. 23.

FIG. 26 is a circuit diagram of a sensor pixel circuit according to a seventh embodiment of the present invention.

FIG. 27 is a diagram showing operations of the sensor pixel circuit shown in FIG. 26.

FIG. 28 is a signal waveform diagram of the sensor pixel circuit shown in FIG. 26.

FIG. 29 is a circuit diagram of a sensor pixel circuit according to an eighth embodiment of the present invention.

FIG. 30 is a diagram showing operations of the sensor pixel circuit shown in FIG. 29.

FIG. 31 is a signal waveform diagram of the sensor pixel circuit shown in FIG. 29.

FIG. 32 is a circuit diagram of sensor pixel circuits according to a ninth embodiment of the present invention.

FIG. 33 is a diagram showing operations of the sensor pixel circuits shown in FIG. 32.

FIG. 34 is a signal waveform diagram of the sensor pixel circuits shown in FIG. 32.

FIG. 35 is a circuit diagram of sensor pixel circuits according to a tenth embodiment of the present invention.

FIG. 36 is a diagram showing operations of the sensor pixel circuits shown in FIG. 35.

FIG. 37 is a circuit diagram of sensor pixel circuits according to an eleventh embodiment of the present invention.

FIG. 38 is a circuit diagram of sensor pixel circuits according to a twelfth embodiment of the present invention.

FIG. 39 is a circuit diagram of a sensor pixel circuit according to a thirteenth embodiment of the present invention.

FIG. 40 is a circuit diagram of a sensor pixel circuit according to a fourteenth embodiment of the present invention.

FIG. 41 is a circuit diagram of a sensor pixel circuit according to a fifteenth embodiment of the present invention.

FIG. 42A is a circuit diagram of a sensor pixel circuit according to a first modification example of the first embodiment.

FIG. 42B is a circuit diagram of a sensor pixel circuit according to a second modification example of the first embodiment.

FIG. 42C is a circuit diagram of a sensor pixel circuit according to a third modification example of the first embodiment.

FIG. 42D is a circuit diagram of a sensor pixel circuit according to a fourth modification example of the first embodiment.

FIG. 42E is a circuit diagram of a sensor pixel circuit according to a fifth modification example of the first embodiment.

FIG. 42F is a circuit diagram of a sensor pixel circuit according to a sixth modification example of the first embodiment.

FIG. 42G is a circuit diagram of a sensor pixel circuit according to a seventh modification example of the first embodiment.

FIG. 43 is a circuit diagram of sensor pixel circuits according to a modification example of the ninth embodiment.

FIG. 44 is a diagram showing turn-on and turn-off timings of a backlight as well as reset and read timings of light receiving elements, in a conventional input/output device.

FIG. 45 is a circuit diagram of a unit light receiving section included in a conventional solid-state imaging device.

### MODES FOR CARRYING OUT THE INVENTION

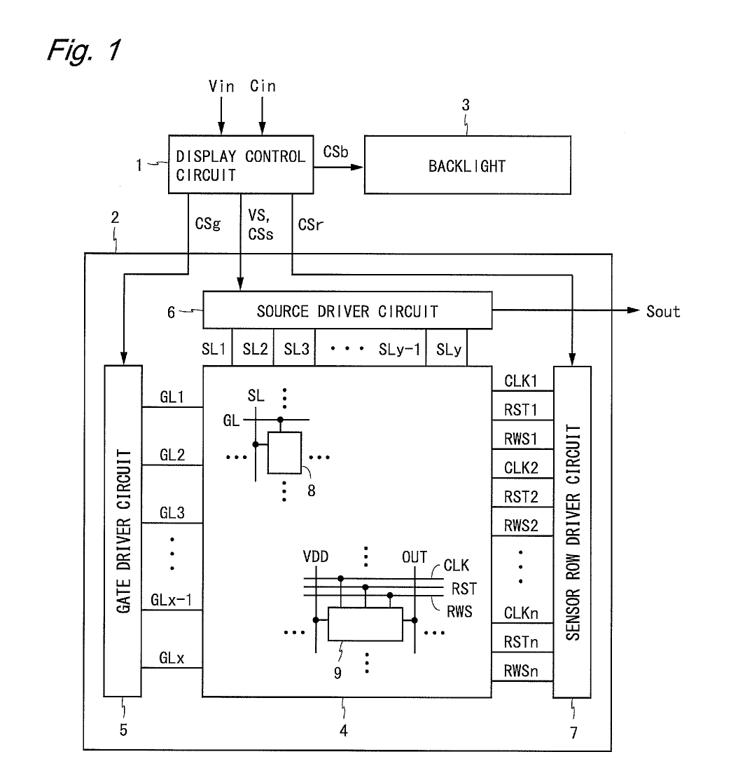

FIG. 1 is a block diagram showing a configuration of a display device according to one embodiment of the present invention. As shown in FIG. 1, the display device includes a display control circuit 1, a display panel 2 and a backlight 3. The display panel 2 includes a pixel region 4, a gate driver circuit 5, a source driver circuit 6 and a sensor row driver circuit 7. The pixel region 4 includes a plurality of display pixel circuits 8 and a plurality of sensor pixel circuits 9. This display device has a function of displaying an image on the display panel 2, and a function of sensing light incident on the display panel 2. In the following definition, “x” represents an integer of not less than 2, “y” represents a multiple of 3, “m” and “n” each represent an even number, and a frame rate of the display device is 60 frames per second.

To the display device shown in FIG. 1, a video signal Vin and a timing control signal Cin are supplied from the outside. Based on these signals, the display control circuit 1 outputs a video signal VS and control signals CSg, CSs and CSr to the display panel 2, and outputs a control signal CSb to the backlight 3. The video signal VS may be equal to the video signal Vin, or may be a signal corresponding to the video signal Vin subjected to signal processing.

The backlight 3 is a light source for irradiating light to the display panel 2. More specifically, the backlight 3 is provided on a back side of the display panel 2, and irradiates light to the back of the display panel 2. The backlight 3 is turned on when the control signal CSb is in a HIGH level, and is turned off when the control signal CSb is in a LOW level.

In the pixel region 4 of the display panel 2, the (x×y) display pixel circuits 8 and the (n×m/2) sensor pixel circuits 9 are arranged in a two-dimensional array, respectively. More specifically, “x” gate lines GL1 to GLx and “y” source lines SL1 to SLy are formed in the pixel region 4. The gate lines GL1 to GLx are arranged in parallel to one another, and the source lines SL1 to SLy are arranged in parallel to one another so as to be orthogonal to the gate lines GL1 to GLx. The (x×y) display pixel circuits 8 are arranged in the vicinity of intersections between the gate lines GL1 to GLx and the source lines SL1 to SLy. Each display pixel circuit 8 is connected to one gate line GL and one source line SL. The display pixel circuits 8 are classified into those for red display, those for green display and those for blue display. These three types of display pixel circuits 8 are arranged and aligned in an extending direction of the gate lines GL1 to GLx to form one color pixel.

In the pixel region 4, “n” clock lines CLK1 to CLKn, “n” reset lines RST1 to RSTn and “n” read lines RWS1 to RWSn are formed in parallel to the gate lines GL1 to GLx. Moreover, in the pixel region 4, other signal lines and power supply lines (not shown) are formed in parallel to the gate lines GL1 to GLx in some cases. In the case where read from the sensor pixel circuits 9 is performed, “m” source lines selected from among the source lines SL1 to SLy are used as power supply lines VDD1 to VDDm, and different “m” source lines are used as output lines OUT1 to OUTm.

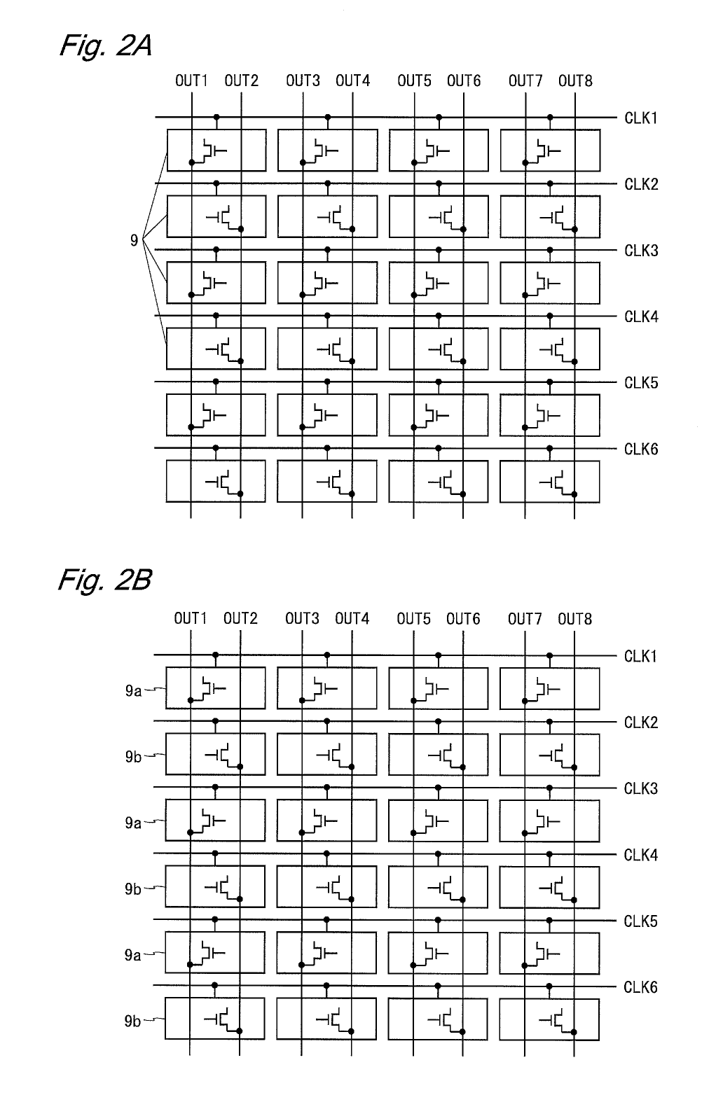

The display device according to this embodiment employs the case where the sensor pixel circuits 9 of one type are arranged in the pixel region 4 and the case where the sensor pixel circuits 9 of two types are arranged in the pixel region 4. FIG. 2A is a diagram showing a first example of the arrangement of the sensor pixel circuits 9 in the pixel region 4. In the first example, the sensor pixel circuits 9 are of one type. As shown in FIG. 2A, the (n×m/2) sensor pixel circuits 9 are arranged in the vicinity of intersections between the odd-numbered clock lines CLK1 to CLKn−1 and the odd-numbered output lines OUT1 to OUTm−1 and in the vicinity of intersections between the even-numbered clock lines CLK2 to CLKn and the even-numbered output lines OUT2 to OUTm.

FIG. 2B is a diagram showing a second example of the arrangement of the sensor pixel circuits 9 in the pixel region 4. In the second example, the sensor pixel circuits 9 are of two types. The (n×m/2) sensor pixel circuits 9 include first sensor pixel circuits 9a each sensing light to be incident during a turn-on period of the backlight 3 and second sensor pixel circuit 9b each sensing light to be incident during a turn-off period of the backlight 3. The first sensor pixel circuits 9a are equal in number to the second sensor pixel circuits 9b. In FIG. 2B, the (n×m/4) first sensor pixel circuits 9a are arranged in the vicinity of intersections between the odd-numbered clock lines CLK1 to CLKn−1 and the odd-numbered output lines OUT1 to OUTm−1. The (n×m/4) second sensor pixel circuits 9b are arranged in the vicinity of intersections between the even-numbered clock lines CLK2 to CLKn and the even-numbered output lines OUT2 to OUTm. In this case, the display panel 2 includes the plurality of output lines OUT1 to OUTm for propagating output signals from the first sensor pixel circuits 9a and output signals from the second sensor pixel circuits 9b, and the first sensor pixel circuit 9a and the second sensor pixel circuit 9b are connected to the different output lines depending on the type.

The gate driver circuit 5 drives the gate lines GL1 to GLx. More specifically, based on the control signal CSg, the gate driver circuit 5 selects one gate line sequentially from among the gate lines GL1 to GLx, applies a HIGH-level potential to the selected gate line, and applies a LOW-level potential to the remaining gate lines. Thus, the “y” display pixel circuits 8 connected to the selected gate line are selected collectively.

The source driver circuit 6 drives the source lines SL1 to SLy. More specifically, based on the control signal CSs, the source driver circuit 6 applies potentials corresponding to the video signal VS to the source lines SL1 to SLy. Herein, the source driver circuit 6 may perform line sequential drive, or may perform dot sequential drive. The potentials applied to the source lines SL1 to SLy are written to the “y” display pixel circuits 8 selected by the gate driver circuit 5. As described above, it is possible to write the potentials corresponding to the video signal VS to all the display pixel circuits 8 by use of the gate driver circuit 5 and the source driver circuit 6, thereby displaying a desired image on the display panel 2.

The sensor row driver circuit 7 drives the clock lines CLK1 to CLKn, the reset lines RST1 to RSTn, the read lines RWS1 to RWSn, and the like. More specifically, based on the control signal CSr, the sensor row driver circuit 7 applies a HIGH-level potential to the clock lines CLK1 to CLKn when the backlight 3 is turned on, and applies a LOW-level potential to the clock lines CLK1 to CLKn when the backlight 3 is turned off. Moreover, based on the control signal CSr, the sensor row driver circuit 7 selects one or two reset line(s) sequentially from among the reset lines RST1 to RSTn, applies a HIGH-level potential for reset to the selected reset line(s), and applies a LOW-level potential to the remaining reset lines. Thus, the (m/2) or “m” sensor pixel circuits 9 connected to the selected reset line(s) are reset collectively.

Moreover, based on the control signal CSr, the sensor row driver circuit 7 selects one or two read line(s) sequentially from among the read lines RWS1 to RWSn, applies a HIGH-level potential for read to the selected read line(s), and applies a LOW-level potential to the remaining read lines. Thus, the (m/2) or “m” sensor pixel circuits 9 connected to the selected read line(s) turn to a readable state collectively. Herein, the source driver circuit 6 applies a HIGH-level potential to the power supply lines VDD1 to VDDm. Thus, the (m/2) or “m” sensor pixel circuits 9 in the readable state output signals corresponding to amounts of light sensed by the respective sensor pixel circuits 9 (hereinafter, referred to as sensor signals) to the output lines OUT1 to OUTm.

In the case where the sensor pixel circuits 9 are of one type, the source driver circuit 6 amplifies the sensor signals output to the output lines OUT1 to OUTm, and outputs the amplified signals sequentially, as a sensor output Sout, to the outside of the display panel 2. In the case where the sensor pixel circuits 9 are of two types, the source driver circuit 6 is provided with a difference circuit (not shown) that obtains a difference between the output signal from the first sensor pixel circuit 9a and the output signal from the second sensor pixel circuit 9b. In this case, the source driver circuit 6 amplifies the differences between the two amounts of light obtained by the difference circuit, and outputs the amplified signals as a sensor output Sout to the outside of the display panel 2. As described above, by reading the sensor signals from all the sensor pixel circuits 9 by use of the source driver circuit 6 and the sensor row driver circuit 7, it is possible to sense light incident on the display panel 2. The display device shown in FIG. 1 performs the following consecutive drive in order to sense light incident on the display panel 2.

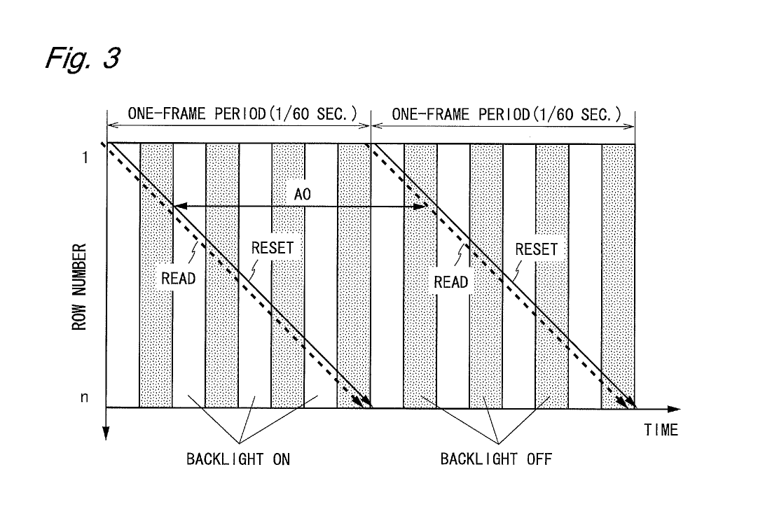

FIG. 3 is a diagram showing turn-on and turn-off timings of the backlight 3 as well as reset and read timings of the sensor pixel circuits 9. As shown in FIG. 3, the backlight 3 is turned on a plurality of times and is turned off a plurality of times in a one-frame period. It is assumed in the following description that the backlight 3 is turned on four times and is turned off four times in a one-frame period. A turn-on period is equal in length to a turn-off period. The reset for the sensor pixel circuits 9 is performed in a line sequential manner over a one-frame period (a solid line arrow). The read from the sensor pixel circuits 9 is performed after a lapse of almost the one-frame period from the reset (more specifically, after a lapse of a time which is slightly shorter than the one-frame period) (a broken line arrow).

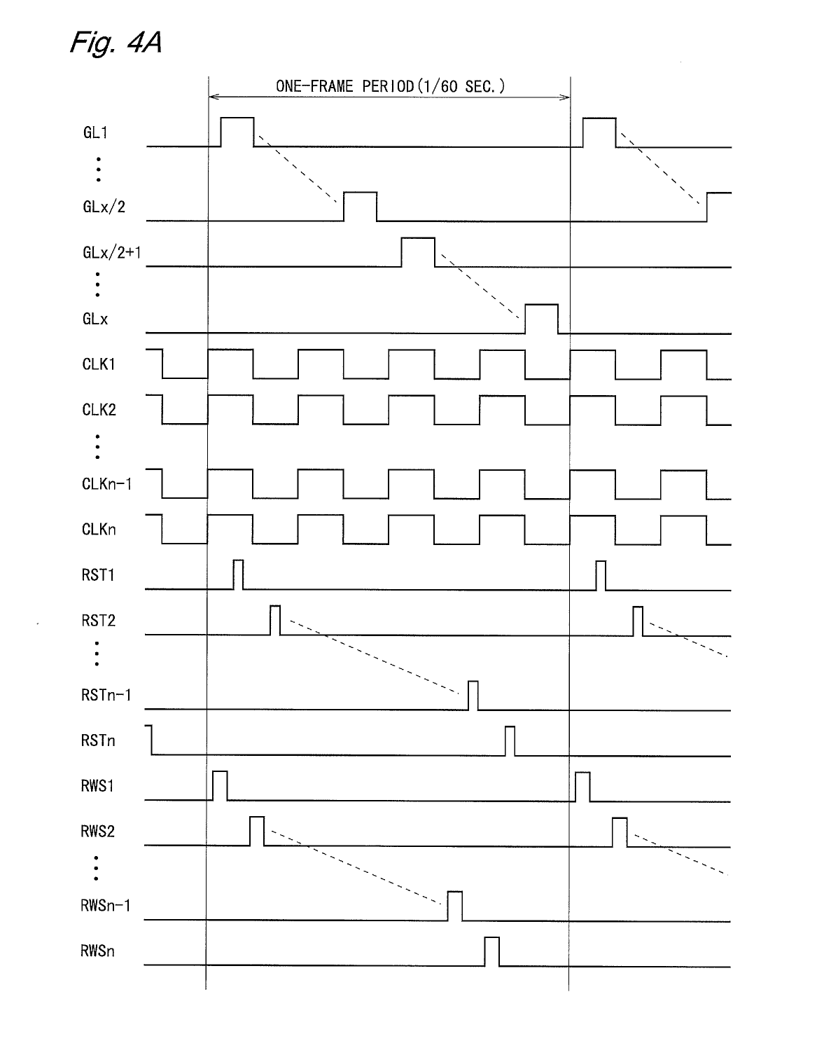

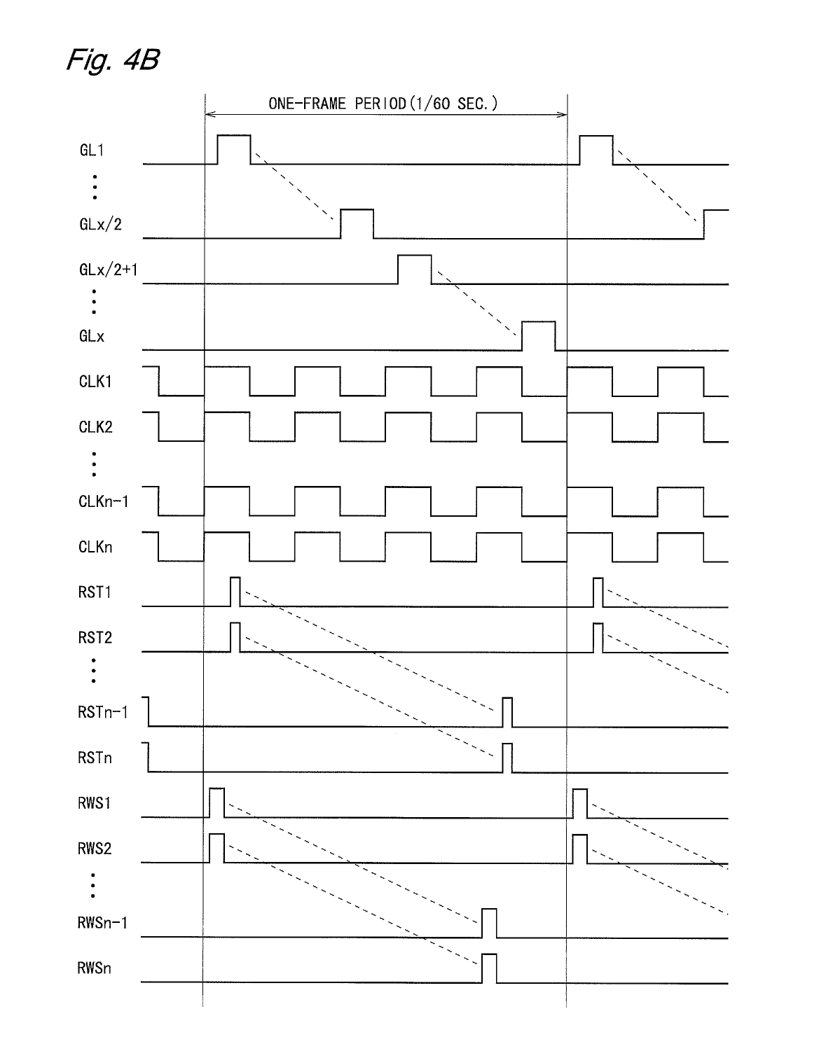

FIG. 4A is a signal waveform diagram of the first example for the display panel 2. In the first example, the sensor pixel circuits 9 are of one type. In this example, potentials at the gate lines GL1 to GLx sequentially turn to a HIGH level once for a predetermined time in a one-frame period. Potentials at the clock lines CLK1 to CLKn change at the same timing, and turn to the HIGH level and the LOW level four times, respectively, in the one-frame period. With regard to the potentials at the clock lines CLK1 to CLKn, the HIGH-level period is equal in length to the LOW-level period. Potentials at the reset lines RST1 to RSTn sequentially turn to the HIGH level once for a predetermined time in the one-frame period. Potentials at the read lines RWS1 to RWSn also sequentially turn to the HIGH level once for a predetermined time in the one-frame period.

FIG. 4B is a signal waveform diagram of the second example for the display panel 2. In the second example, the sensor pixel circuits 9 are of two types. In this example, potentials at the gate lines GL1 to GLx and the clock lines CLK1 to CLKn change as in those in the first example. The reset lines RST1 to RSTn are provided in twos, and the potentials at the (n/2) pairs of reset lines sequentially turn to the HIGH level once for a predetermined time in the one-frame period. The read lines RWS1 to RWSn are also provided in twos, and the potentials at the (n/2) pairs of read lines sequentially turn to the HIGH level once for a predetermined time in the one-frame period.

Both in the first and second examples, immediately after the potential at the read line RWS1 changes from the HIGH level to the LOW level, the potential at the reset line RST1 changes from the LOW level to the HIGH level. Similar things hold true for the potentials at the reset lines RST2 to RSTn. Therefore, a period during which the sensor pixel circuit 9 senses light (a period from the reset to the read: AO shown in FIG. 3) becomes almost equal in length to the one-frame period.

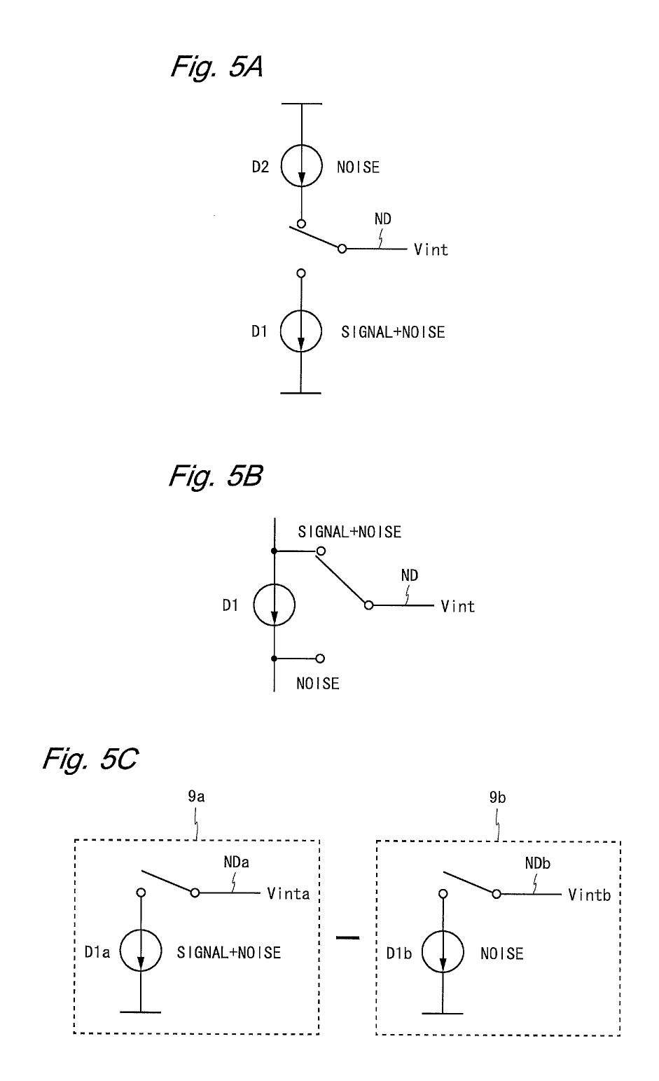

The sensor pixel circuit 9 employs one of the following three configurations. FIG. 5A is a diagram showing an outline of the sensor pixel circuit 9 employing the first configuration. As shown in FIG. 5A, the sensor pixel circuit 9 includes two photodiodes D1 and D2, and one accumulation node ND. The photodiode D1 pulls out, of the accumulation node ND, charge corresponding to an amount of light to be incident while the backlight 3 is turned on. On the other hand, the photodiode D2 adds, to the accumulation node ND, charge corresponding to an amount of light to be incident while the backlight 3 is turned off. Therefore, a potential Vint at the accumulation node ND drops in accordance with the amount of light to be incident during the turn-on period of the backlight 3 (which corresponds to (signal+noise)), and rises in accordance with the amount of light to be incident during the turn-off period of the backlight 3 (which corresponds to noise). This sensor pixel circuit 9 is arranged in the form shown in FIG. 2A, and a sensor signal corresponding to a difference between the amounts of light of two types is read from the sensor pixel circuit 9. Moreover, by obtaining the difference between the amounts of light by use of one sensor pixel circuit, it is possible to perform temperature compensation at the same time.

FIG. 5B is a diagram showing an outline of the sensor pixel circuit 9 employing the second configuration. As shown in FIG. 5B, the sensor pixel circuit 9 employing the second configuration includes one photodiode D1 and one accumulation node ND. The photodiode D1 pulls out, of the accumulation node ND, charge corresponding to an amount of light to be incident while the backlight 3 is turned on, and adds, to the accumulation node ND, charge corresponding to an amount of light to be incident while the backlight 3 is turned off. Therefore, a potential Vint at the accumulation node ND drops in accordance with the amount of light to be incident during a turn-on period of the backlight 3 (which corresponds to (signal+noise)), and rises in accordance with the amount of light to be incident during a turn-off period of the backlight 3 (which corresponds to noise). This sensor pixel circuit 9 is arranged in the form shown in FIG. 2A, and a sensor signal corresponding to a difference between the amounts of light of two types is read from the sensor pixel circuit 9. Moreover, by obtaining the difference between the amounts of light by use of one sensor pixel circuit, it is possible to perform temperature compensation at the same time.

FIG. 5C is a diagram showing configurations of the sensor pixel circuits 9 employing the third configuration. In this case, the sensor pixel circuits 9 include the first sensor pixel circuit 9a and the second sensor pixel circuit 9b. As shown in FIG. 5C, the first sensor pixel circuit 9a includes one photodiode D1a and one accumulation node NDa. The photodiode D1a pulls out, of the accumulation node NDa, charge corresponding to an amount of light to be incident while the backlight 3 is turned on (which corresponds to (signal+noise)). As in the first sensor pixel circuit 9a, the second sensor pixel circuit 9b includes one photodiode D1b and one accumulation node NDb. The photodiode D1b pulls out, of the accumulation node NDb, charge corresponding to an amount of light to be incident while the backlight 3 is turned off (which corresponds to noise). These sensor pixel circuits 9a and 9b are arranged in the form shown in FIG. 2B, and the source driver circuit 6 is provided with the difference circuit described above. A sensor signal corresponding to an amount of light to be incident when the backlight 3 is turned on is read from the first sensor pixel circuit 9a. A sensor signal corresponding to an amount of light to be incident when the backlight 3 is turned off is read from the second sensor pixel circuit 9b. By obtaining the difference between the output signal from the first sensor pixel circuit 9a and the output signal from the second sensor pixel circuit 9b, using the difference circuit included in the source driver circuit 6, it is possible to obtain the difference between the amount of light when the backlight is turned on and the amount of light when the backlight is turned off. In addition, it is possible to perform the temperature compensation.

It is to be noted that the number of sensor pixel circuits 9 to be provided in the pixel region 4 may be arbitrary. For example, the (n×m) sensor pixel circuits 9 may be provided in the pixel region 4. Alternatively, the sensor pixel circuits 9 the number of which is equal to that of color pixels (that is, (x×y/3)) may be provided in the pixel region 4. Alternatively, the sensor pixel circuits 9 the number of which is smaller than that of color pixels (for example, one severalth to one several tenth of color pixels) may be provided in the pixel region 4. However, in the case of using the sensor pixel circuits 9 employing the third configuration, the first sensor pixel circuit 9a and the second sensor pixel circuit 9b are connected to the different output lines. For example, in the case where the (n×m) sensor pixel circuits 9 are provided in the pixel region 4, the “n” first sensor pixel circuits 9a are connected to the odd-numbered output lines OUT1 to OUTm−1 and the “n” second sensor pixel circuits 9b are connected to the even-numbered output lines OUT2 to OUTm.

As described above, the display device according to the embodiment of the present invention is the display device in which the plurality of photodiodes (optical sensors) are arranged in the pixel region 4. The display device includes the display panel 2 that includes the plurality of display pixel circuits 8 and the plurality of sensor pixel circuits 9, the backlight 3 that is turned on and off a plurality of times, respectively, in a one-frame period, and the sensor row driver circuit 7 (drive circuit) that outputs, to the sensor pixel circuits 9, the clock signals CLK1 to CLKn (control signals) indicating that the backlight is turned on or the backlight is turned off and performs the reset for and read from the sensor pixel circuits 9. The sensor row driver circuit 7 performs the reset for the sensor pixel circuits 9 and the read from the sensor pixel circuits 9 in parallel, each in a line sequential manner. The sensor pixel circuit 9 performs the operation for detecting the difference between the amount of light when the backlight is turned on and the amount of light when the backlight is turned off, in accordance with the clock signals CLK1 to CLKn. One sensor pixel circuit 9 may detect the difference between the amount of light when the backlight is turned on and the amount of light when the backlight is turned off (the first and second configurations). Alternatively, the sensor pixel circuits 9 may include the first sensor pixel circuit 9a for detecting the amount of light when the backlight is turned on and the second sensor pixel circuit 9b for detecting the amount of light when the backlight is turned off (the third configuration).

The display device according to this embodiment is allowed to detect a difference between an amount of light when the backlight is turned on and an amount of light when the backlight is turned off even when the sensor pixel circuits 9 are of one type or two types, and to give an input function which does not depend on light environments. Moreover, as compared with the case of detecting two types of amounts of light sequentially by use of one sensor pixel circuit, it is possible to reduce a frequency of the read from the sensor pixel circuits, to retard the read speed, and to reduce power consumption in the device. Moreover, it becomes unnecessary to provide a memory which is required in the case of detecting two types of amounts of light sequentially and is used for storing the amount of light sensed firstly. Moreover, by performing the reset for the sensor pixel circuits and the read from the sensor pixel circuits in parallel, each in a line sequential manner, it is possible to increase the degree of freedom for setting the turn-on and turn-off timings of the backlight as well as the reset and read timings of the sensor pixel circuits, and to retard the reset speed and the read speed. Moreover, by performing the operation of sensing light when the backlight is turned on and the operation of sensing light when the backlight is turned off a plurality of times, respectively, in a one-frame period, it is possible to eliminate a deviation between the sensing period when the backlight is turned on and the sensing period when the backlight is turned off, and to prevent followability to motion input from varying in accordance with a direction of the input.

Moreover, the sensor row driver circuit 7 performs the reset for the sensor pixel circuits 9 and the read from the sensor pixel circuits 9 once, respectively, in the one-frame period over almost the one-frame period. Thus, it is possible to retard the reset speed and the read speed. Moreover, the sensor row driver circuit 7 performs the read from the sensor pixel circuits 9 on one row, and then immediately performs the reset for the sensor pixel circuits 9 on this row. Thus, it is possible to set the period, during which the sensor pixel circuit senses light, at almost the one-frame period. Moreover, the turn-on period of the backlight 3 is equal in length to the turn-off period of the backlight 3. As described above, by detecting the amount of light when the backlight is turned on and the amount of light when the backlight is turned off, with regard to the periods which are equal in length to each other, it is possible to accurately obtain the difference between the amount of light when the backlight is turned on and the amount of light when the backlight is turned off.

Moreover, the display panel 4 further includes the plurality of output lines OUT1 to OUTm for propagating the output signals from the sensor pixel circuits 9. In the case where the sensor pixel circuits 9 are of two types, the first sensor pixel circuit 9a and the second sensor pixel circuit 9b are connected to the different output lines depending on the type. Accordingly, it is possible to perform the read from the first and second sensor pixel circuits 9a and 9b in parallel, to retard the read speed, and to reduce power consumption in the device. Moreover, in this case, the source driver circuit 6 is provided with the difference circuit that obtains the difference between the output signal from the first sensor pixel circuit 9a and the output signal from the second sensor pixel circuit 9b. Accordingly, it is possible to immediately obtain the difference between the two types of amounts of light read in parallel, and to eliminate the need for a memory which is required in the case of detecting the two types of amounts of light sequentially and is used for storing the amount of light sensed firstly.

Hereinafter, description will be given of details of the sensor pixel circuit 9 included in the display device according to this embodiment. In the following description, a sensor pixel circuit is simply referred to as a pixel circuit, and a signal on a signal line is designated using the designation of the signal line for the sake of identification (for example, a signal on a clock line CLK is referred to as a clock signal CLK). The pixel circuit according to each of first to fifth embodiments employs the configuration shown in FIG. 5A, is connected to a clock line CLK, a reset line RST, a read line RWS, a power supply line VDD and an output line OUT, and is supplied with a potential VC. The potential VC is a potential which is higher than a HIGH-level potential for reset. The pixel circuit according to each of sixth to eighth embodiments employs the configuration shown in FIG. 5B, is connected to a clock line CLK, a reset line RST, a read line RWS, a power supply line VDD and an output line OUT, and is supplied with a potential VC and an inverted signal of the clock signal CLK.

The pixel circuit according to each of ninth to fifteenth embodiments employs the configuration shown in FIG. 5C. In the ninth to twelfth embodiments, the first sensor pixel circuit 9a is connected to a clock line CLKa, a reset line RSTa, a read line RWSa, a power supply line VDDa and an output line OUTa. The second sensor pixel circuit 9b is connected to a clock line CLKb, a reset line RSTb, a read line RWSb, a power supply line VDDb and an output line OUTb. In these embodiments, the second sensor pixel circuit 9b has the configuration equal to the first sensor pixel circuit 9a and operates as in the first sensor pixel circuit 9a; therefore, the description about the second sensor pixel circuit 9b is omitted appropriately. In the thirteenth to fifteenth embodiments, the first sensor pixel circuit 9a and the second sensor pixel circuit 9b share a part of constituent elements so as to be configured as one pixel circuit. The pixel circuit according to each of the thirteenth and fourteenth embodiments is connected to a reset line RST and a read line RWS each of which is formed in common. The pixel circuit according to the fifteenth embodiment is connected to a reset line RST, a read line RWS, a power supply line VDD and an output line OUT each of which is formed in common.

### FIRST EMBODIMENT

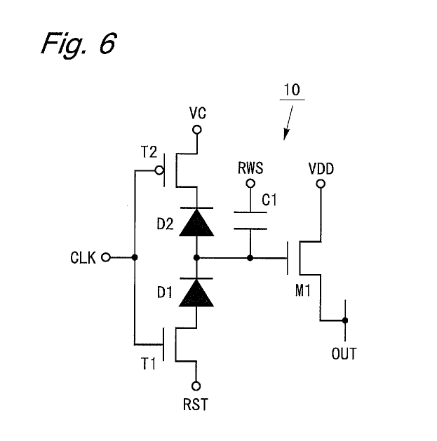

FIG. 6 is a circuit diagram of a pixel circuit according to a first embodiment of the present invention. A pixel circuit shown in FIG. 6 includes transistors T1, T2 and M1, photodiodes D1 and D2, and a capacitor C1. Each of the transistors T1 and M1 is an N-type TFT (Thin Film Transistor), and the transistor T2 is a P-type TFT.

As shown in FIG. 6, gates of the transistors T1 and T2 are connected to a clock line CLK. In the transistor T1, a source is connected to a reset line RST, and a drain is connected to an anode of the photodiode D1. In the transistor T2, a source is applied with a potential VC, and a drain is connected to a cathode of the photodiode D2. A cathode of the photodiode D1 and an anode of the photodiode D2 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 10, a node connected to the gate of the transistor M1 serves as an accumulation node that accumulates charge corresponding to an amount of sensed light, and the transistor M1 functions as a read transistor.

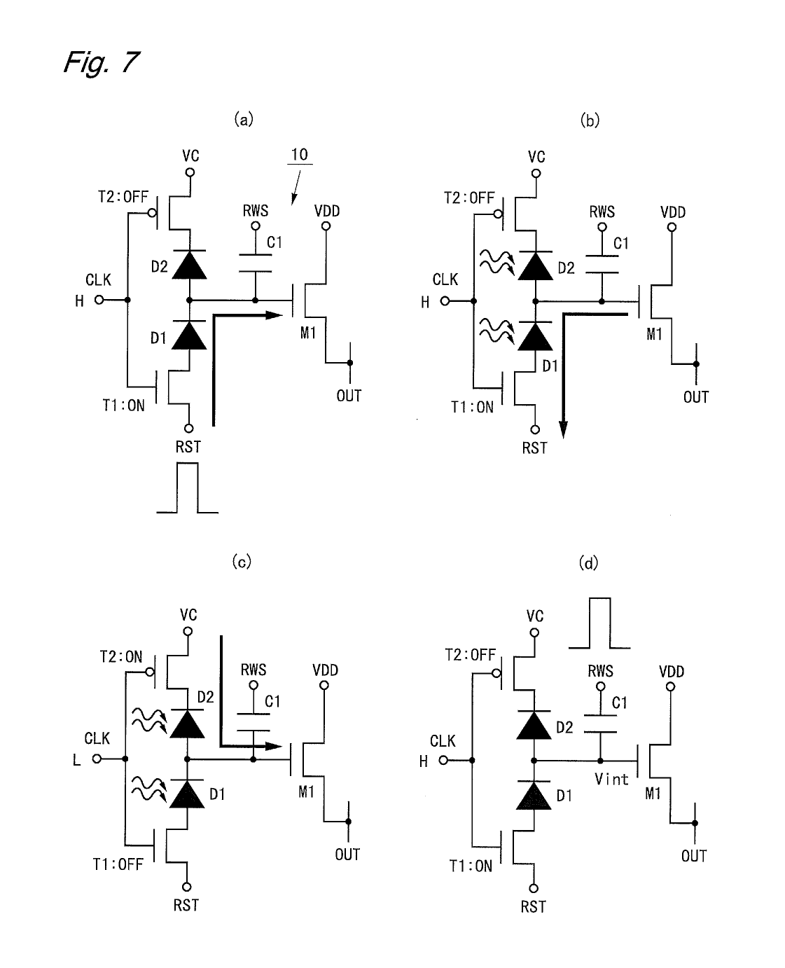

FIG. 7 is a diagram showing operations of the pixel circuit 10. As shown in FIG. 7, the pixel circuit 10 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period.

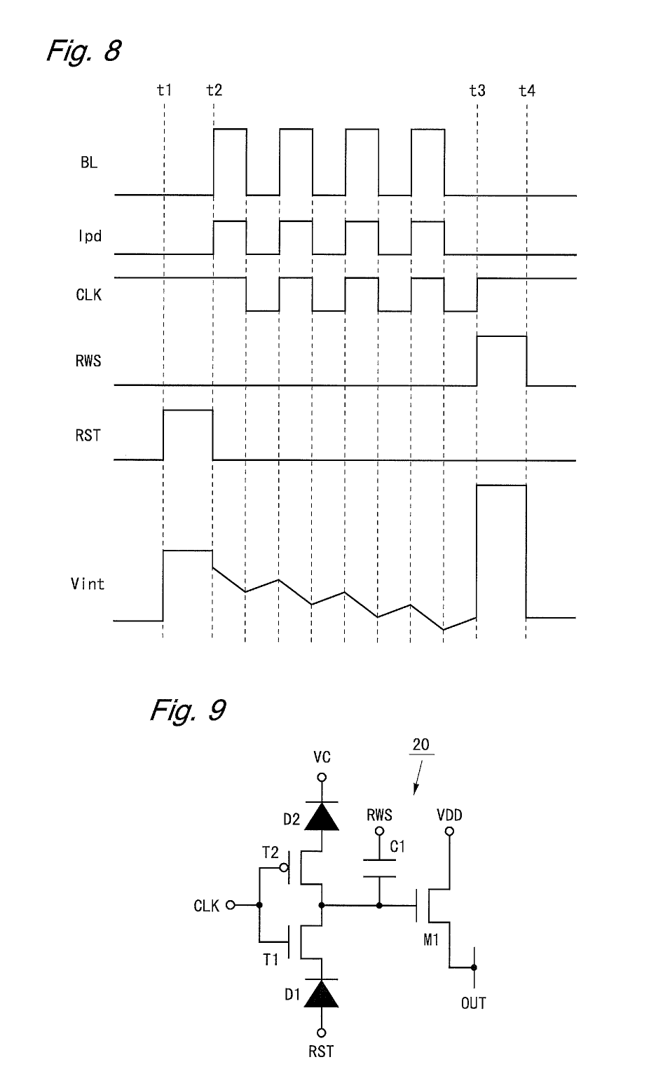

FIG. 8 is a signal waveform diagram of the pixel circuit 10. In FIG. 8, BL represents a brightness of the backlight 3, Ipd represents a current flowing through the photodiode, and Vint represents a potential at the accumulation node (a gate potential at the transistor M1). In FIG. 8, a reset period corresponds to a range from a time t1 to a time t2, an accumulation period corresponds to a range from the time t2 to a time t3, and a read period corresponds to a range from the time t3 to a time t4.

In the reset period, a clock signal CLK turns to a HIGH level, a read signal RWS turns to a LOW level, and a reset signal RST turns to a HIGH level for reset. Herein, the transistor T1 turns on, and the transistor T2 turns off. Accordingly, a current (a forward current in the photodiode D1) flows from the reset line RST into the accumulation node via the transistor T1 and the photodiode D1 (FIG. 7 (a)), and the potential Vint is reset to a predetermined level.

In the accumulation period, the reset signal RST and the read signal RWS turn to the LOW level, and the clock signal CLK turns to the HIGH level and the LOW level four times, respectively. While the clock signal CLK is in the HIGH level, the transistor T1 turns on and the transistor T2 turns off. Herein, when light is incident on the photodiodes D1 and D2, a current (a photocurrent in the photodiode D1) flows from the accumulation node into the reset line RST via the photodiode D1 and the transistor T1, and charge is pulled out of the accumulation node (FIG. 7 (b)). Accordingly, the potential Vint drops in accordance with an amount of light to be incident while the clock signal CLK is in the HIGH level (during a turn-on period of the backlight 3).

On the other hand, while the clock signal CLK is in the LOW level, the transistor T1 turns off and the transistor T2 turns on. Herein, when light is incident on the photodiodes D1 and D2, a current (a photocurrent in the photodiode D2) flows from a wire having a potential VC into the accumulation node via the transistor T2 and the photodiode D2, and charge is added to the accumulation node (FIG. 7 (c)). Accordingly, the potential Vint rises in accordance with an amount of light to be incident while the clock signal CLK is in the LOW level (during a turn-off period of the backlight 3).

In the read period, the clock signal CLK turns to the HIGH level, the reset signal RST turns to the LOW level, and the read signal RWS turns to a HIGH level for read. Herein, the transistor T1 turns on, and the transistor T2 turns off. Herein, the potential Vint rises by an amount which is (Cq/Cp) times (Cp: a capacitance value of the entire pixel circuit 10, Cq: a capacitance value of the capacitor C1) as large as a rise amount of a potential at the read signal RWS. The transistor M1 constitutes a source follower amplification circuit having, as a load circuit, a transistor (not shown) included in the source driver circuit 6, and drives the output line OUT in accordance with the potential Vint (FIG. 7 (d)).

As described above, the pixel circuit 10 according to this embodiment includes the two photodiodes D1 and D2 (first and second optical sensors), the one accumulation node which accumulates the charge corresponding to an amount of sensed light, the transistor M1 (read transistor) which has the gate connected to the accumulation node, the transistor T1 (first switching element) which is provided on the path for the current flowing through the photodiode D1 and turns on when the backlight is turned on in accordance with the clock signal CLK, and the transistor T2 (second switching element) which is provided on the path for the current flowing through the photodiode D2 and turns on when the backlight is turned off in accordance with the clock signal CLK. The photodiode D1 is provided between the accumulation node and one of the ends of the transistor T1, and the photodiode D2 is provided between the accumulation node and one of the ends of the transistor T2. The other end of the transistor T1 is connected to the reset line RST, and the other end of the transistor T2 is applied with the predetermined potential VC.

When the backlight is turned on, the transistor T1 turns on, and the potential at the accumulation node drops because of the current flowing through the photodiode D1. When the backlight is turned off, the transistor T2 turns on, and the potential at the accumulation node rises because of the current flowing through the photodiode D2. As described above, the potential at the accumulation node changes in reverse direction when the backlight is turned on and when the backlight is turned off. According to the pixel circuit 10, thus, it is possible to detect a difference between the amount of light when the backlight is turned on and the amount of light when the backlight is turned off, by use of one sensor pixel circuit.

### SECOND EMBODIMENT

FIG. 9 is a circuit diagram of a pixel circuit according to a second embodiment of the present invention. A pixel circuit 20 shown in FIG. 9 includes transistors T1, T2 and M1, photodiodes D1 and D2, and a capacitor C1. Each of the transistors T1 and M1 is an N-type TFT, and the transistor T2 is a P-type TFT.

As shown in FIG. 9, gates of the transistors T1 and T2 are connected to a clock line CLK. In the photodiode D1, an anode is connected to a reset line RST, and a cathode is connected to a source of the transistor T1. In the photodiode D2, a cathode is applied with a potential VC, and an anode is connected to a source of the transistor T2. Drains of the transistors T1 and T2 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 20, a node connected to the gate of the transistor M1 serves as an accumulation node, and the transistor M1 functions as a read transistor.

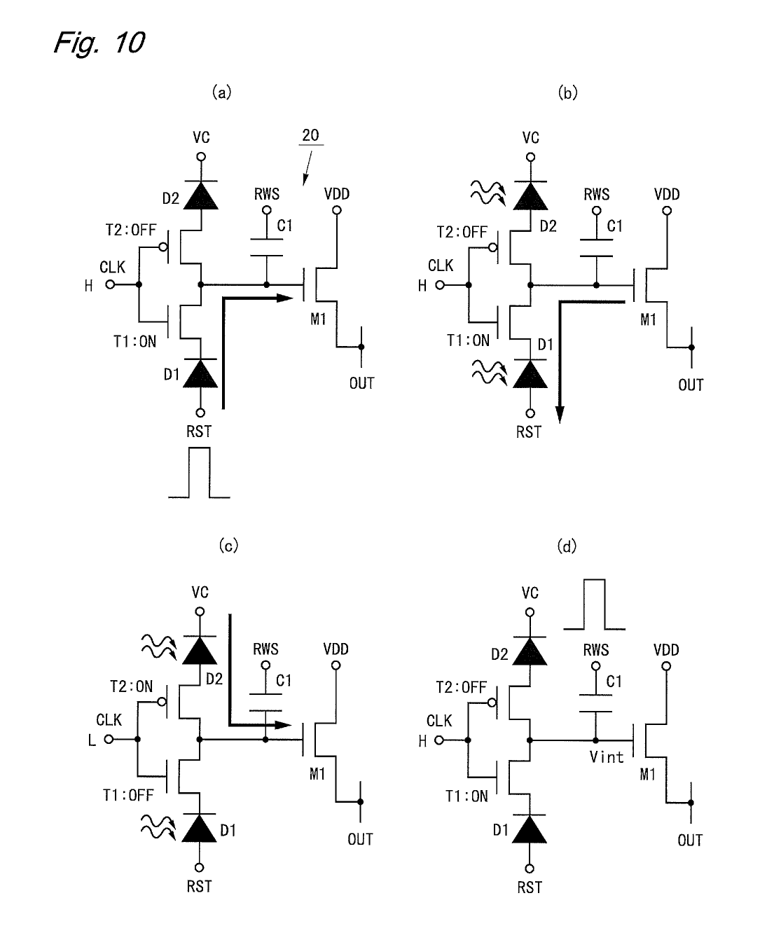

FIG. 10 is a diagram showing operations of the pixel circuit 20. As shown in FIG. 10, the pixel circuit 20 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 20 is equal to that in the first embodiment (FIG. 8). The pixel circuit 20 operates as in the pixel circuit 10 according to the first embodiment.

As described above, as in the pixel circuit 10 according to the first embodiment, the pixel circuit 20 according to this embodiment includes the two photodiodes D1 and D2, the one accumulation node, the transistor M1, the transistor T1 which turns on when the backlight is turned on, and the transistor T2 which turns on when the backlight is turned off. The transistor T1 is provided between the accumulation node and one of the ends of the photodiode D1, and the transistor T2 is provided between the accumulation node and one of the ends of the photodiode D2. The other end of the photodiode D1 is connected to the reset line RST, and the other end of the photodiode D2 is applied with the predetermined potential VC.

When the backlight is turned on, the transistor T1 turns on, and a potential at the accumulation node drops because of a current flowing through the photodiode D1. When the backlight is turned off, the transistor T2 turns on, and the potential at the accumulation node rises because of a current flowing through the photodiode D2. As described above, the potential at the accumulation node changes in reverse direction when the backlight is turned on and when the backlight is turned off. According to the pixel circuit 20, it is possible to detect a difference between an amount of light when the backlight is turned on and an amount of light when the backlight is turned off, by use of one sensor pixel circuit.

Moreover, in the case of changing the potential at the accumulation node to perform read, the photodiode D2 on the side of the transistor T2 which is in an OFF state is disconnected electrically from the accumulation node. Accordingly, it is possible to reduce a capacitance of the accumulation node at the time of read, and to readily change the potential at the accumulation node.

### THIRD EMBODIMENT

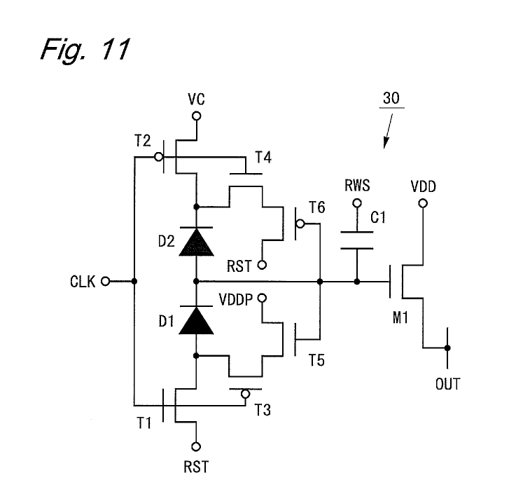

FIG. 11 is a circuit diagram of a pixel circuit according to a third embodiment of the present invention. A pixel circuit 30 shown in FIG. 11 includes transistors T1 to T6 and M1, photodiodes D1 and D2, and a capacitor C1. Each of the transistors T1, T4, T5 and M1 is an N-type TFT, and each of the transistors T2, T3 and T6 is a P-type TFT. In addition to a potential VC, a potential VDDP, which is higher than a HIGH-level potential for reset, is supplied to the pixel circuit 30. The potential VDDP may be a potential which is equal to the potential VC.

As shown in FIG. 11, gates of the transistors T1 to T4 are connected to a clock line CLK. In the transistor T1, a source is connected to a reset line RST, and a drain is connected to an anode of the photodiode D1 and a drain of the transistor T3. In the transistor T2, a source is applied with the potential VC, and a drain is connected to a cathode of the photodiode D2 and a drain of the transistor T4. A cathode of the photodiode D1 and an anode of the photodiode D2 are connected to a gate of the transistor M1. In the transistor M1, a drain is connected to a power supply line VDD, and a source is connected to an output line OUT. The capacitor C1 is provided between the gate of the transistor M1 and a read line RWS. Gates of the transistors T5 and T6 are connected to the gate of the transistor M1. In the transistor T5, a drain is applied with the potential VDDP, and a source is connected to a source of the transistor T3. In the transistor T6, a drain is connected to the reset line RST, and a source is connected to a source of the transistor T4. In the pixel circuit 30, a node connected to the gate of the transistor M1 serves as an accumulation node, and the transistor M1 functions as a read transistor.

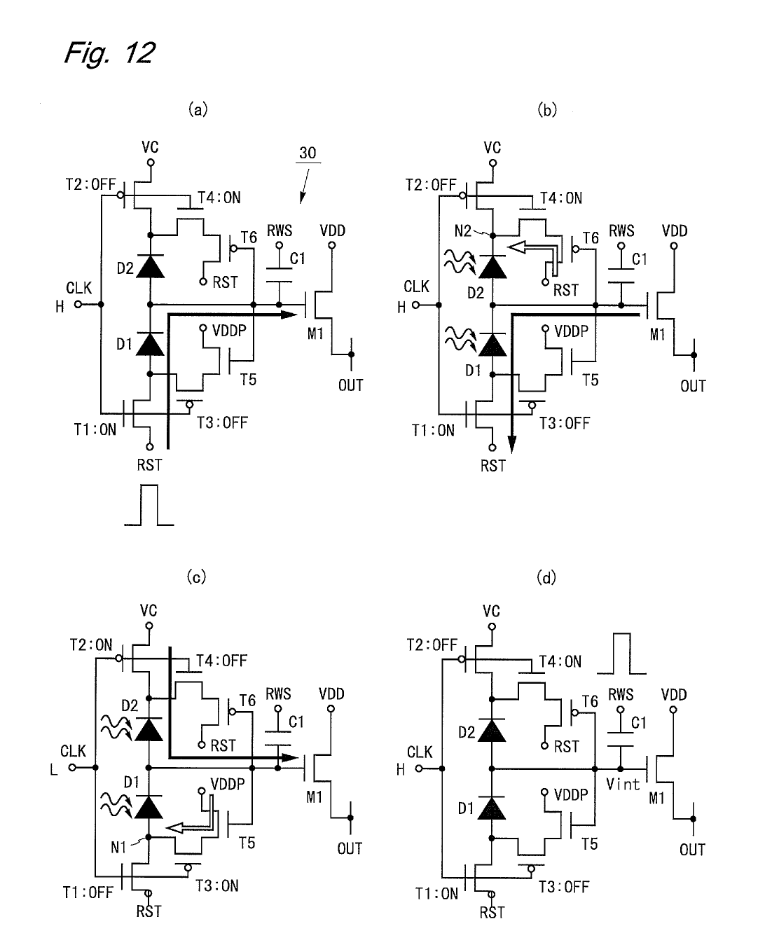

FIG. 12 is a diagram showing operations of the pixel circuit 30. As shown in FIG. 12, the pixel circuit 30 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 30 is equal to that in the first embodiment (FIG. 8).

The pixel circuit 30 operates as in the pixel circuit 10 according to the first embodiment, except for the following points. The transistor T3 turns on or off as in the transistor T2, and the transistor T4 turns on or off as in the transistor T1. In an accumulation period, when a clock signal CLK changes from a LOW level to a HIGH level, the transistor T4 changes off to on. At this moment, a node N2 connected to the cathode of the photodiode D2 is charged with a potential corresponding to a gate potential Vint at the transistor M1, via the transistors T4 and T6 (a white arrow in FIG. 12 (b)). Therefore, a current flowing through the photodiode D2 is interrupted immediately when the clock signal CLK changes from the LOW level to the HIGH level.

On the other hand, in the accumulation period, when the clock signal CLK changes from the HIGH level to the LOW level, the transistor T3 changes off to on. At this moment, a node N1 connected to the anode of the photodiode D1 is charged with the potential corresponding to the gate potential Vint at the transistor M1, via the transistors T3 and T5 (a white arrow in FIG. 12 (c)). Therefore, a current flowing through the photodiode D1 is interrupted immediately when the clock signal CLK changes from the HIGH level to the LOW level.

As described above, the pixel circuit 30 according to this embodiment corresponds to the pixel circuit 10 according to the first embodiment additionally including the transistor T3 (third switching element) which has one of the ends connected to the transistor T1-side terminal of the photodiode D1 and turns on when the backlight is turned off, in accordance with the clock signal CLK, the transistor T4 (fourth switching element) which has one of ends connected to the transistor T2-side terminal of the photodiode D2 and turns on when the backlight is turned on in accordance with the clock signal CLK, the transistor T5 (fifth switching element) which feeds the potential corresponding to the potential at the accumulation node to the other end of the transistor T3, and the transistor T6 (sixth switching element) which feeds the potential corresponding to the potential at the accumulation node to the other end of the transistor T4.

According to the pixel circuit 30, in addition to the effects of the pixel circuit 10 according to the first embodiment, by applying the potentials corresponding to the potential at the accumulation node to the terminals, which are opposed to the accumulation node, of the photodiodes D1 and D2 upon change of the clock signal CLK, it is possible to immediately interrupt the currents flowing through the photodiodes D1 and D2, and to enhance detection accuracy.

### FOURTH EMBODIMENT

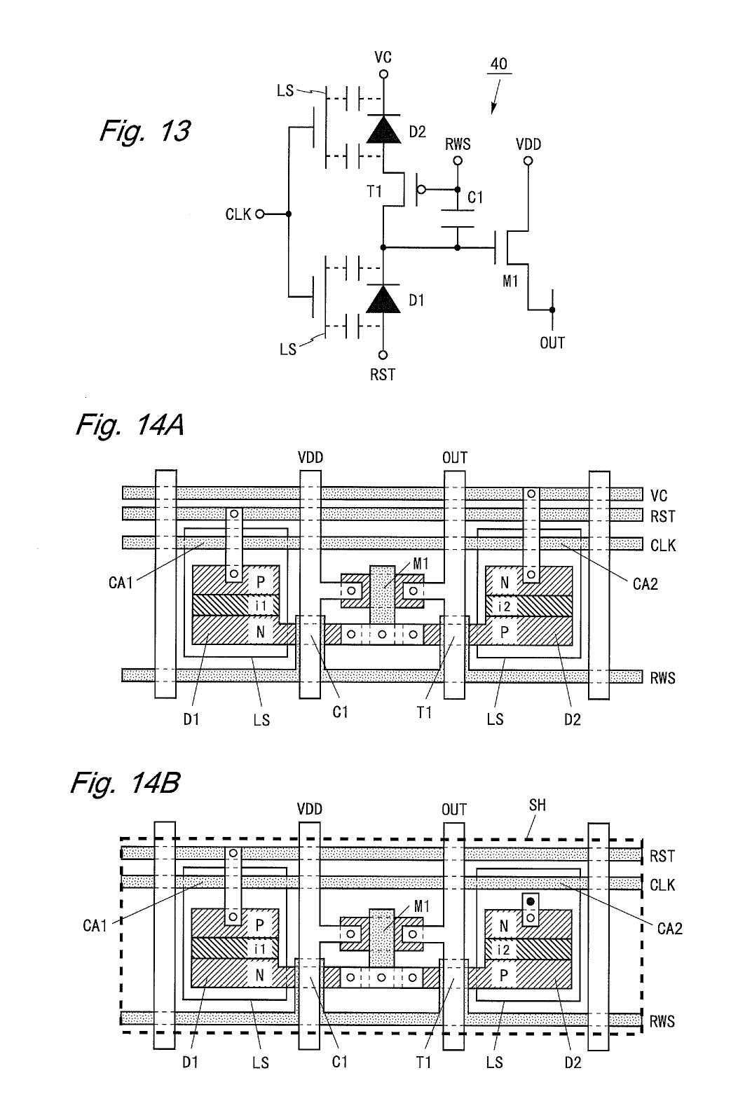

FIG. 13 is a circuit diagram of a pixel circuit according to a fourth embodiment of the present invention. A pixel circuit 40 shown in FIG. 13 includes transistors T1 and M1, photodiodes D1 and D2, and a capacitor C1. The transistor T1 is a P-type TFT, and the transistor M1 is an N-type TFT.

As shown in FIG. 13, an anode of the photodiode D1 is connected to a reset line RST. In the photodiode D2, a cathode is applied with a potential VC, and an anode is connected to a source of the transistor T1. A cathode of the photodiode D1 and a drain of the transistor T1 are connected to a gate of the transistor M1. In the transistor M1, a drain is connected to a power supply line VDD, and a source is connected to an output line OUT. The capacitor C1 is provided between the gate of the transistor M1 and a read line RWS. A gate of the transistor T1 is connected to the read line RWS. In the pixel circuit 40, a node connected to the gate of the transistor M1 serves as an accumulation node, and the transistor M1 functions as a read transistor. A clock line CLK and a light shielding film LS will be described later.

FIG. 14A is a layout diagram of the pixel circuit 40. As shown in FIG. 14A, the pixel circuit 40 has a configuration that a light shielding film LS, a semiconductor layer (hatch pattern portion), a gate wiring layer (dot pattern portion) and a source wiring layer (white portions) are formed sequentially on a glass substrate. A contact (shown with a white circle) is provided at a place where the semiconductor layer and the source wiring layer are connected, and a place where the gate wiring layer and the source wiring layer are connected. The transistors T1 and M1 are formed by arranging the semiconductor layer and the gate wiring layer so that these two layers cross one another. The photodiodes D1 and D2 are formed by arranging a P layer, an I layer and an N layer included in the semiconductor layers so that these three layers are aligned. The capacitor C1 is formed by arranging the semiconductor layer and the gate wiring layer so that these two layers overlap. The light shielding film LS is made of metal, and prevents light entering through the back of the glass substrate from being incident on the photodiodes D1 and D2.

FIG. 14B is another layout diagram of the pixel circuit 40. According to the layout shown in FIG. 14B, the potential VC is applied to a shield SH (a transparent electrode: shown with a bold broken line) for covering a layout surface, and a contact (shown with a black circle) is provided at a place where the shield SH and the source wiring layer are connected. It is to be noted that the layout of the pixel circuit 40 may be changed in a form other than those described above.

The clock line CLK is arranged to cross the light shielding films LS of the photodiodes D1 and D2. A capacitor CA1 is formed at a position where the clock line CLK crosses the light shielding film LS of the photodiode D1, and a capacitor CA2 is formed at a position where the clock line CLK crosses the light shielding film LS of the photodiode D2. As described above, the light shielding films LS of the photodiodes D1 and D2 are coupled to the clock line CLK via the capacitors CA1 and CA2, respectively.

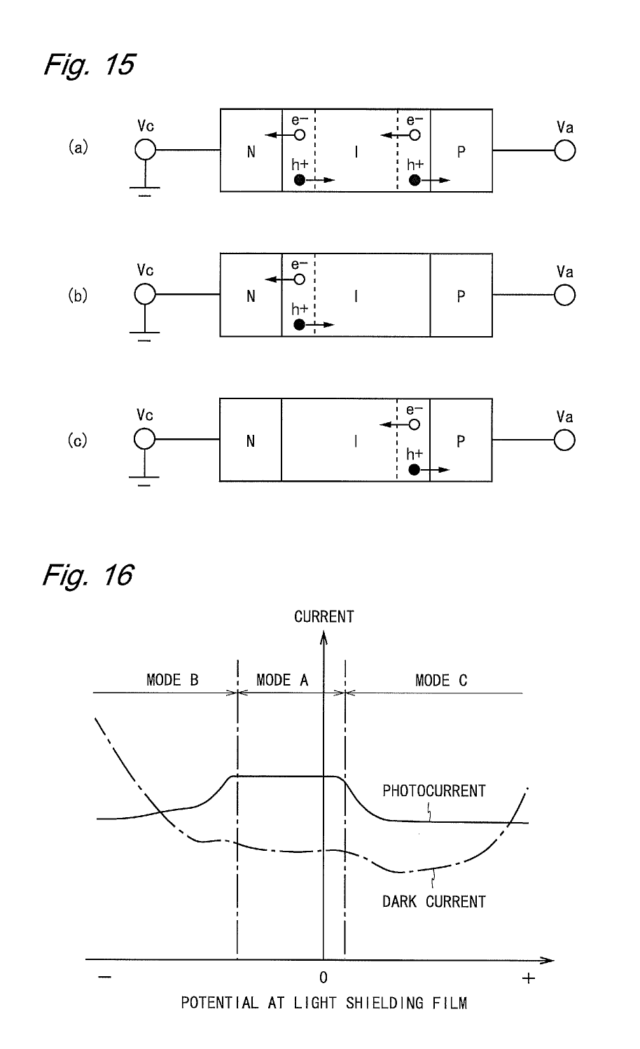

In general, the sensitivity of a photodiode varies in accordance with a potential at a light shielding film formed on a lower layer of the photodiode. With reference to FIGS. 15 and 16, hereinafter, description will be given of this matter. FIG. 15 is a diagram showing a situation that the state of the photodiode changes in accordance with the potential at the light shielding film. As shown in FIG. 15, in the case of a photodiode including a P layer, an I layer and an N layer, Va represents an anode potential, Vc represents a cathode potential, and Vg represents a potential at a light shielding film (not shown). Moreover, Vth_p represents a threshold voltage of an imaginary P-type MOS transistor in which a P layer serves as a source/drain region, a light shielding film serves as a gate electrode, and an insulating film (not shown) formed between a semiconductor layer and the light shielding film serves as a gate insulating film, and Vth_n represents a threshold voltage of an imaginary N-type MOS transistor in which an N layer serves as a source/drain region, a light shielding film serves as a gate electrode, and the above-mentioned film serves as a gate insulating film.

The state of the photodiode changes based on whether the potential Vg of the light shielding film satisfies any of Expressions (1) to (3) described below. Hereinafter, the case where the potential Vg satisfies Expression (1) is referred to as a mode A, the case where the potential Vg satisfies Expression (2) is referred to as a mode B, and the case where the potential Vg satisfies Expression (3) is referred to as a mode C.

(Va+Vth_{—}p)<Vg<(Vc+Vth_{—}n) (1)

Vg<(Va+Vth_{—}p)<(Vc+Vth_{—}n) (2)

(Va+Vth_{—}p)<(Vc+Vth_{—}n)<Vg (3)

In the mode A, free electrons and positive holes are apt to move in the proximity of two interfaces of the I layer (FIG. 15 (a)). Therefore, in the mode A, a current flows smoothly through the photodiode. In contrast to this, in the mode B, free electrons and positive holes are apt to move in the proximity of only the N layer-side interface of the I layer (FIG. 15 (b)). In the mode C, free electrons and positive holes are apt to move in the proximity of only the P layer-side interface of the I layer (FIG. 15 (c)). Therefore, in the mode B and the mode C, the flow of current is interrupted by the I layer.

FIG. 16 is a diagram showing a relation between a potential at the light shielding film and currents flowing through the photodiode. In FIG. 16, a horizontal axis denotes the potential at the light shielding film, and a vertical axis denotes the currents flowing through the photodiode. As shown in FIG. 16, the photocurrent and dark current in the photodiode vary in accordance with the potential at the light shielding film. The photocurrent in the mode A becomes larger in amount than the photocurrents in the mode B and mode C.

As described above, the light shielding films LS of the photodiodes D1 and D2 included in the pixel circuit 40 are connected to the clock line CLK via the capacitors CA1 and CA2, respectively. Therefore, when the potential at the clock line CLK changes, the potentials at the light shielding films LS of the photodiodes D1 and D2 also change and, in association with this change, the sensitivities of the photodiodes D1 and D2 also change. Moreover, typically, in the case of forming a photodiode, it is possible to adjust the sensitivity of the photodiode by adjusting a doping amount in a semiconductor layer.

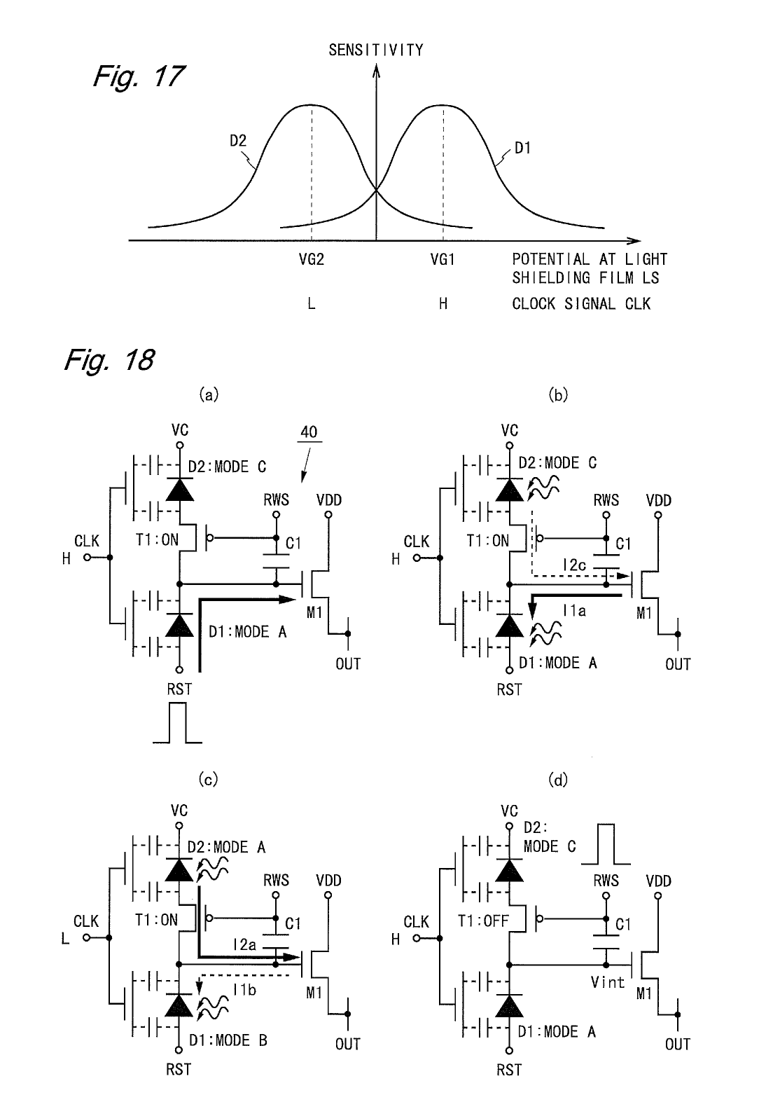

FIG. 17 is a diagram showing sensitivity characteristics of the photodiodes D1 and D2. As shown in FIG. 17, the photodiodes D1 and D2 are configured to have different sensitivity characteristics by adjustment of doping amounts in the semiconductor layers. More specifically, in the case where VG1 represents a potential at the light shielding film LS when the clock signal CLK is in a HIGH level and VG2 represents a potential at the light shielding film LS when the clock signal CLK is in a LOW level, the photodiodes D1 and D2 are configured so that the sensitivity of the photodiode D1 becomes higher than that of the photodiode D2 when the potential at the light shielding film LS is VG1 and the sensitivity of the photodiode D1 becomes lower than that of the photodiode D2 when the potential at the light shielding film LS is VG2. Hereinafter, it is assumed that when the potential at the light shielding film LS is almost VG1, the photodiode D1 operates in the mode A and the photodiode D2 operates in the mode C, and when the potential at the light shielding film LS is almost VG2, the photodiode D1 operates in the mode B and the photodiode D2 operates in the mode A.

FIG. 18 is a diagram showing operations of the pixel circuit 40. As shown in FIG. 18, the pixel circuit 40 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 40 is equal to that in the first embodiment (FIG. 8).

In a reset period, the clock signal CLK turns to the HIGH level, a read signal RWS turns to a LOW level, and a reset signal RST turns to a HIGH level for reset. Herein, the transistor T1 turns on. Moreover, a current (a forward current in the photodiode D1) flows from the reset line RST into the accumulation node via the photodiode D1 (FIG. 18 (a)), and a potential Vint is reset to a predetermined level.

In an accumulation period, the reset signal RST and the read signal RWS turn to the LOW level, and the clock signal CLK turns to the HIGH level and the LOW level four times, respectively. Herein, the transistor T1 turns on. While the clock signal CLK is in the HIGH level, the photodiode D1 operates in the mode A, and the photodiode D2 operates in the mode C. Herein, when light is incident on the photodiodes D1 and D2, a current I1a (a photocurrent upon operation in the mode A) flows from the accumulation node into the reset line RST via the photodiode D1, and charge is pulled out of the accumulation node. In association with this, a current I2c (a photocurrent upon operation in the mode C) flows from a wire having the potential VC into the accumulation node via the photodiode D2 and the transistor T1, and charge is added to the accumulation node (FIG. 18 (b)). Since the relation of I1a>I2c is satisfied, the potential Vint drops in accordance with an amount of light to be incident while the clock signal CLK is in the HIGH level (a turn-on period of the backlight 3).

On the other hand, while the clock signal CLK is in the LOW level, the photodiode D1 operates in the mode B, and the photodiode D2 operates in the mode A. Herein, when light is incident on the photodiodes D1 and D2, a current I1b (a photocurrent upon operation in the mode B) flows from the accumulation node into the reset line RST via the photodiode D1, and charge is pulled out of the accumulation node. In association with this, a current I2a (a photocurrent upon operation in the mode A) flows from the wire having the potential VC into the accumulation node via the photodiode D2 and the transistor T1, and charge is added to the accumulation node (FIG. 18 (c)). Since the relation of I1b<I2a is satisfied, the potential Vint rises in accordance with an amount of light to be incident while the clock signal CLK is in the LOW level (a turn-off period of the backlight 3).

In a read period, the clock signal CLK turns to the HIGH level, the reset signal RST turns to the LOW level, and the read signal RWS turns to a HIGH level for read. Herein, the transistor T1 turns off. Herein, the potential Vint rises by an amount which is (Cq/Cp) times (Cp: a capacitance value of the entire pixel circuit 40, Cq: a capacitance value of the capacitor C1) as large as a rise amount of the potential at the read signal RWS. The transistor M1 constitutes a source follower amplification circuit, and drives the output line OUT in accordance with the potential Vint (FIG. 18 (d)).

In the case where Ion represents a photocurrent when the clock signal CLK is in the HIGH level, Ioff represents a photocurrent when the clock signal CLK is in the LOW level, Ix represents a photocurrent based on light from the backlight, and Iy represents a photocurrent based on external light, Expression (4) described below is established when the clock signal CLK is in the HIGH level, and Expression (5) described below is established when the clock signal CLK is in the LOW level. Moreover, Expression (6) described below is established with regard to the photodiode D1 when the clock signal CLK is in the HIGH level, and Expression (7) described below is established with regard to the photodiode D2 when the clock signal CLK is in the LOW level.

Ion=I1a−I2c (4)

Ioff=I2a−I1b (5)

I1a=Ix+Iy (6)

I2a=Iy (7)

Herein, with regard to the photodiodes D1 and D2, in the case where the sensitivity in the mode B is equal to the sensitivity in the mode C and the sensitivity in the mode A is seven times as large as the sensitivities in the modes B and C, Expression (8) described below is derived from the relations of I2c=(1/7)×I1a and I1b=(1/7)×I2a.

$$\begin{matrix}Ion - Ioff = ( 6 / 7 ) \times I 1 a - ( 6 / 7 ) \times I 2 a \\ = ( 6 / 7 ) \times ( Ix + Iy ) - ( 6 / 7 ) \times Iy \\ = ( 6 / 7 ) \times Ix\end{matrix} \qquad ( 8 )$$

As described above, the difference (Ion−Ioff) between the photocurrent when the clock signal CLK is in the HIGH level and the photocurrent when the clock signal CLK is in the LOW level does not contain the photocurrent Iy based on the external light. Accordingly, by obtaining the difference (Ion−Ioff) between the photocurrents, it is possible to correctly detect only the photocurrent based on light from the backlight.

As described above, the pixel circuit 40 according to this embodiment includes the photodiodes D1 and D2 (first and second optical sensors), the one accumulation node which accumulates the charge corresponding to the amount of sensed light, and the transistor M1 (read transistor) which has the gate connected to the accumulation node. The clock line CLK (control line) for propagating the clock signal CLK is connected to the light shielding films LS formed on the photodiodes D1 and D2 via the capacitors. The sensitivity characteristics of the photodiodes D1 and D2 change in different manners in accordance with the clock signal CLK, and the same clock signal CLK is fed to the photodiodes D1 and D2.

The light shielding films LS of the photodiodes D1 and D2 are connected to the clock line CLK via the capacitors. Thus, when the potential at the clock line CLK changes, the potentials at the light shielding films LS change, and the sensitivity characteristics of the photodiodes D1 and D2 change. Accordingly, the photodiodes D1 and D2 having the sensitivity characteristics shown in FIG. 17 are controlled using the same clock signal CLK. Thus, when the backlight is turned on, a current flowing through the photodiode D1 becomes larger in amount than a current flowing through the photodiode D2, and a potential at the accumulation node drops because of the current flowing through the photodiode D1. On the other hand, when the backlight is turned off, the current flowing through the photodiode D2 becomes larger in amount than the current flowing through the photodiode D1, and the potential at the accumulation node rises because of the current flowing through the photodiode D2. As described above, the potential at the accumulation node changes in reverse direction when the backlight is turned on and when the backlight is turned off. According to the pixel circuit 40, hence, it is possible to detect a difference between the amount of light when the backlight is turned on and the amount of light when the backlight is turned off, by use of one sensor pixel circuit.

Moreover, the pixel circuit 40 includes the capacitor C1 which is provided between the accumulation node and the read line RWS, and the transistor T1 (switching element) which is provided between the accumulation node and one of the ends of the photodiode D2, and turns off when the HIGH-level potential for read is applied to the read line RWS. The photodiode D1 is provided between the accumulation node and the reset line RST, and the other end of the photodiode D2 is applied with the predetermined potential VC. Accordingly, the photodiodes D1 and D2 are connected electrically to the accumulation node every time during the sensing period. Therefore, it is possible to prevent errors due to left charge and to enhance detection accuracy. Moreover, there is attained an effect that it is unnecessary to provide contacts on the light shielding films LS of the photodiodes D1 and D2.

### FIFTH EMBODIMENT

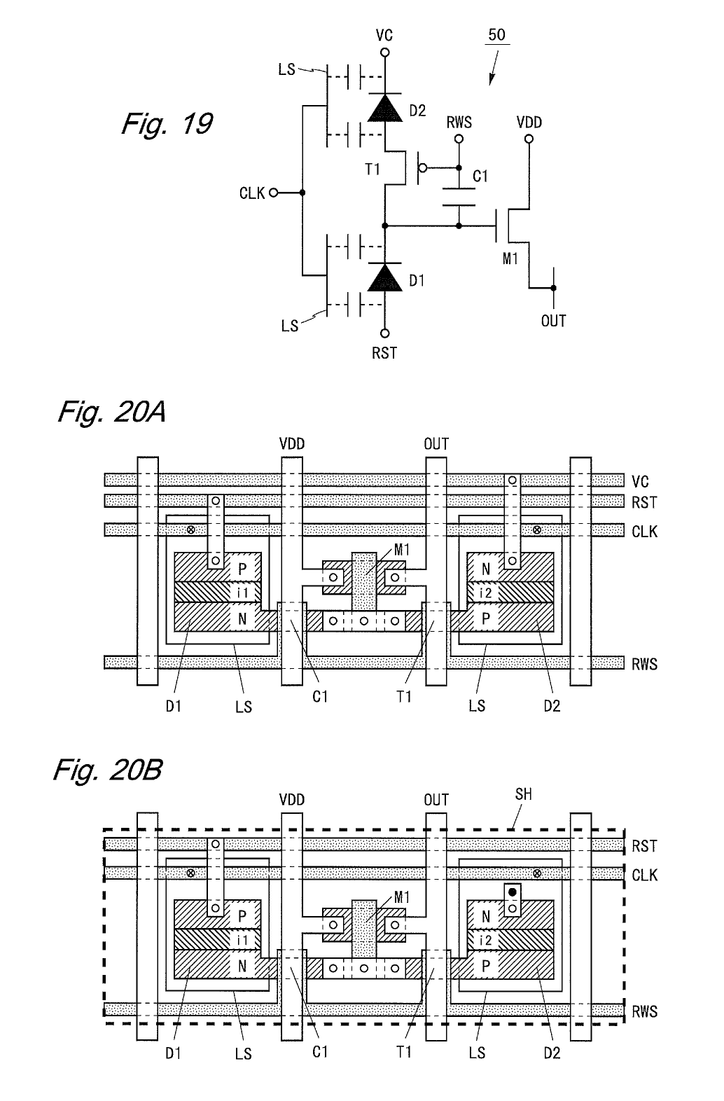

FIG. 19 is a circuit diagram of a pixel circuit according to a fifth embodiment of the present invention. A pixel circuit 50 shown in FIG. 19 includes transistors T1 and M1, photodiodes D1 and D2, and a capacitor C1. The transistor T1 is a P-type TFT, and the transistor M1 is an N-type TFT. The transistors T1 and M1, the photodiodes D1 and D2, and the capacitor C1 are connected in a form which is similar to that in the pixel circuit 40 according to the fourth embodiment.

FIGS. 20A and 20B are layout diagrams of the pixel circuit 50. The description about these drawings is similar to that in the fourth embodiment, except for the following points. A clock line CLK is arranged to cross light shielding films LS of the photodiodes D1 and D2. A contact (shown with a circle having a cross placed therein) is provided at a place where the clock line CLK crosses the light shielding film LS of the photodiode D1 and a place where the clock line CLK crosses the light shielding film LS of the photodiode D2. As described above, the clock line CLK is connected electrically to the light shielding films LS of the photodiodes D1 and D2 via the contacts. According to the layout shown in FIG. 20B, the potential VC is applied to the shield SH for covering a layout surface.

As in the fourth embodiment, the photodiodes D1 and D2 are configured to have different sensitivity characteristics by adjustment of doping amounts in the semiconductor layers (FIG. 17). A signal waveform diagram of the pixel circuit 50 is equal to that in the first embodiment (FIG. 8). The pixel circuit 50 operates as in the pixel circuit 40 according to the fourth embodiment (FIG. 18).

As described above, as in the pixel circuit 40 according to the fourth embodiment, the pixel circuit 50 according to this embodiment includes the two photodiodes D1 and D2, the one accumulation node, and the transistor M1. The clock line CLK (control line) for propagating a clock signal CLK is connected electrically to the light shielding films LS formed on the photodiodes D1 and D2. The sensitivity characteristics of the photodiodes D1 and D2 change indifferent manners in accordance with the clock signal CLK, and the same clock signal CLK is fed to the photodiodes D1 and D2.

The light shielding films LS of the photodiodes D1 and D2 are connected electrically to the clock line CLK. Thus, when a potential at the clock line CLK changes, potentials at the light shielding films LS change, and the sensitivity characteristics of the photodiodes D1 and D2 change. Accordingly, as in the pixel circuit 40 according to the fourth embodiment, by using the photodiodes D1 and D2 having the sensitivity characteristics shown in FIG. 17, a potential at the accumulation node changes in reverse direction when a backlight is turned on and when the backlight is turned off. According to the pixel circuit 50, hence, it is possible to detect a difference between an amount of light when the backlight is turned on and an amount of light when the backlight is turned off, by use of one sensor pixel circuit.

Moreover, as in the pixel circuit 40 according to the fourth embodiment, it is possible to prevent errors due to left charge and to enhance detection accuracy. Moreover, as compared with the pixel circuit 40 according to the fourth embodiment, when the potential at the clock line CLK changes, the potentials at the light shielding film LS change largely, and the sensitivities of the photodiodes D1 and D2 change largely. Accordingly, even in the case of using a clock signal CLK which is small in amplitude, it is possible to change the sensitivities of the photodiodes D1 and D2 largely, and to detect the difference between the amount of light when the backlight is turned on and the amount of light when the backlight is turned off.

(Modification Examples of Fourth and Fifth Embodiments)

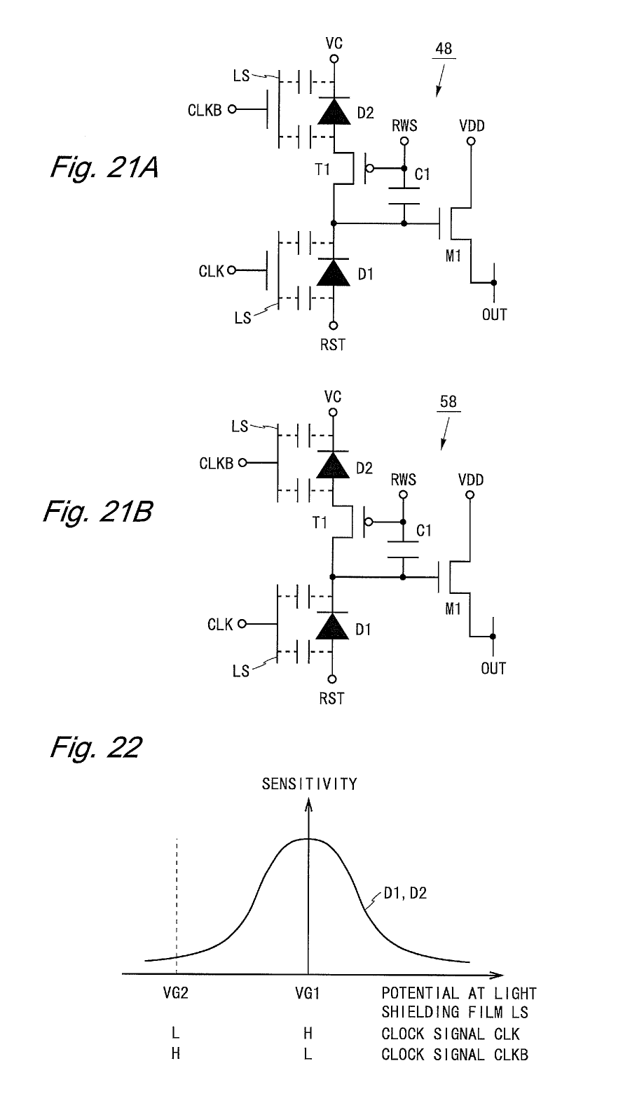

FIG. 21A is a circuit diagram of a pixel circuit according to a modification example of the fourth embodiment. FIG. 21B is a circuit diagram of a pixel circuit according to a modification example of the fifth embodiment. Each of a pixel circuit 48 shown in FIG. 21A and a pixel circuit 58 shown in FIG. 21B is connected to a clock line CLKB for propagating an inverted signal of a clock signal CLK, in addition to a clock line CLK.

In the pixel circuits 48 and 58, the clock line CLK is arranged to cross a light shielding film of a photodiode D1, but not to cross a light shielding film of a photodiode D2. The clock line CLKB is arranged to cross the light shielding film of the photodiode D2, but not to cross the light shielding film of the photodiode D1. Moreover, in the pixel circuit 58, the clock line CLK is connected electrically to the light shielding film of the photodiode D1 via a contact. The clock line CLKB is connected electrically to the light shielding film of the photodiode D2 via a contact.

FIG. 22 is a diagram showing sensitivity characteristics of the photodiodes D1 and D2 included in each of the pixel circuits 48 and 58. As shown in FIG. 22, the photodiodes D1 and D2 are configured to have the same sensitivity characteristics. In the case where VG1 represents a potential at the light shielding film LS when the clock signal CLK is in a HIGH level (the clock signal CLKB is in a LOW level) and VG2 represents a potential at the light shielding film LS when the clock signal CLK is in the LOW level (the clock signal CLKB is in the HIGH level), the photodiodes D1 and D2 are configured so that the sensitivity becomes relatively high when the potential at the light shielding film LS is VG1 and the sensitivity becomes relatively low when the potential at the light shielding film LS is VG2.

The photodiodes D1 and D2 having the sensitivity characteristics shown in FIG. 22 are controlled by use of the different clock signals CLK and CLKB. Thus, when a backlight is turned on, a current flowing through the photodiode D1 becomes larger in amount than a current flowing through the photodiode D2, and a potential at an accumulation node drops because of the current flowing through the photodiode D1. On the other hand, when the backlight is turned off, the current flowing through the photodiode D2 becomes larger in amount than the current flowing through the photodiode D1, and the potential at the accumulation node rises because of the current flowing through the photodiode D2. As described above, the potential at the accumulation node changes in reverse direction when the backlight is turned on and when the backlight is turned off. According to the pixel circuits 48 and 58, as in the pixel circuits 40 and 50, it is possible to detect a difference between an amount of light when the backlight is turned on and an amount of light when the backlight is turned off, by use of one sensor pixel circuit.

### SIXTH EMBODIMENT

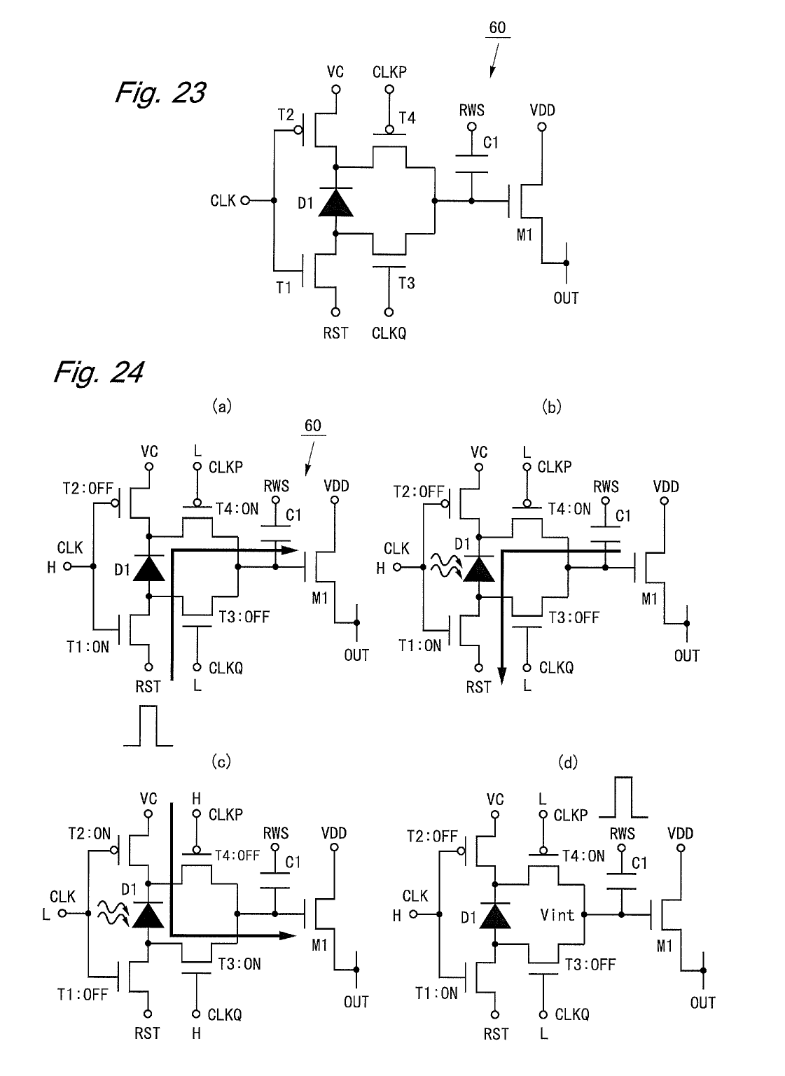

FIG. 23 is a circuit diagram of a pixel circuit according to a sixth embodiment of the present invention. A pixel circuit 60 shown in FIG. 23 includes transistors T1 to T4 and M1, a photodiode D1, and a capacitor C1. Each of the transistors T1, T3 and M1 is an N-type TFT, and each of the transistors T2 and T4 is a P-type TFT. The pixel circuit 60 is connected to three clock lines CLK, CLKP and CLKQ.

As shown in FIG. 23, gates of the transistors T1 and T2 are connected to the clock line CLK, a gate of the transistor T3 is connected to the clock line CLKQ, and a gate of the transistor T4 is connected to the clock line CLKP. In the transistor T1, a source is connected to a reset line RST, and a drain is connected to an anode of the photodiode D1 and a drain of the transistor T3. In the transistor T2, a source is applied with a potential VC, and a drain is connected to a cathode of the photodiode D1 and a drain of the transistor T4. Sources of the transistors T3 and T4 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 60, a node connected to the gate of the transistor M1 serves as an accumulation node that accumulates charge corresponding to an amount of sensed light, and the transistor M1 functions as a read transistor.

FIG. 24 is a diagram showing operations of the pixel circuit 60. As shown in FIG. 24, the pixel circuit 60 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period.

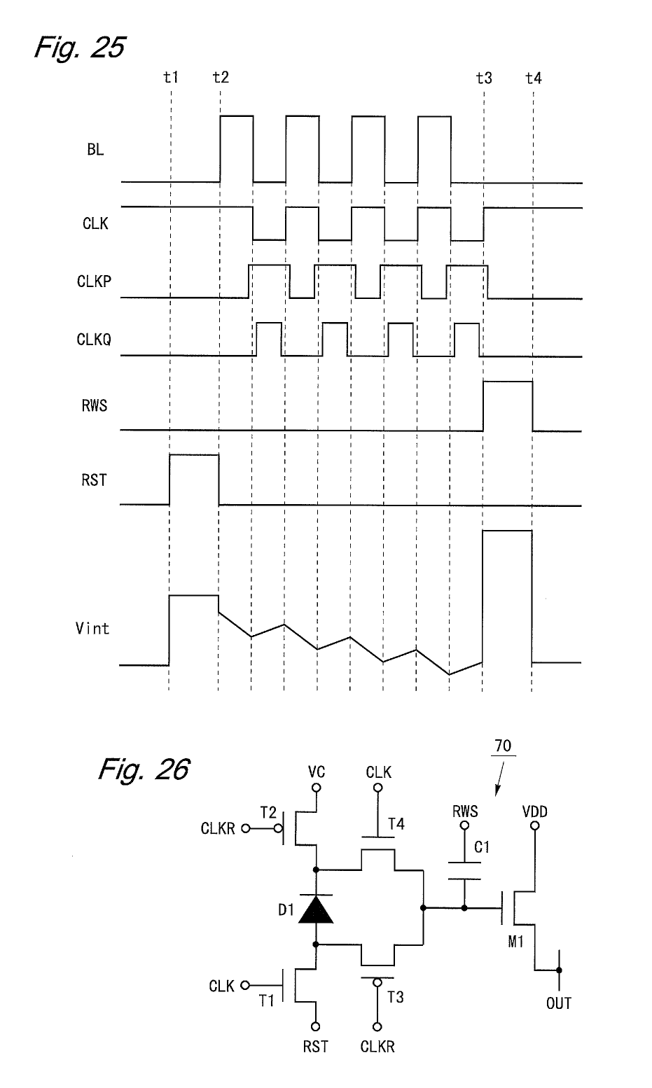

FIG. 25 is a signal waveform diagram of the pixel circuit 60. In FIG. 25, BL represents a brightness of the backlight 3, and Vint represents a potential at the accumulation node (a gate potential at the transistor M1). Each of clock signals CLKP and CLKQ is an inverted signal of a clock signal CLK. However, a LOW-level period of the clock signal CLKP and a HIGH-level period of the clock signal CLKQ are equal in length to each other, and are shorter than a half cycle of the clock signal CLK. In FIG. 25, a reset period corresponds to a range from a time t1 to a time t2, an accumulation period corresponds to a range from the time t2 to a time t3, and a read period corresponds to a range from the time t3 to a time t4.

In the reset period, the clock signal CLK turns to a HIGH level, the clock signals CLKP and CLKQ and a read signal RWS turn to a LOW level, and the reset signal RST turns to a HIGH level for reset. Herein, the transistors T1 and T4 turn on, and the transistors T2 and T3 turn off. Accordingly, a current (a forward current in the photodiode D1) flows from the reset line RST into the accumulation node via the transistor T1, the photodiode D1 and the transistor T4 (FIG. 24 (a)), and the potential Vint is reset to the predetermined level.

In the accumulation period, the reset signal RST and the read signal RWS turn to the LOW level, and the clock signals CLK, CLKP and CLKQ turn to the HIGH level and the LOW level four times, respectively. While the clock signal CLK is in the HIGH level and the clock signals CLKP and CLKQ are in the LOW level, the transistors T1 and T4 turn on and the transistors T2 and T3 turn off. Herein, when light is incident on the photodiode D1, a current (a photocurrent in the photodiode D1) flows from the accumulation node into the reset line RST via the transistor T4, the photodiode D1 and the transistor T1, and charge is pulled out of the accumulation node (FIG. 24 (b)). Accordingly, the potential Vint drops in accordance with an amount of light to be incident while the clock signal CLK is in the HIGH level (during a turn-on period of the backlight 3).

On the other hand, while the clock signal CLK is in the LOW level and the clock signals CLKP and CLKQ are in the HIGH level, the transistors T1 and T4 turn off and the transistors T2 and T3 turn on. Herein, when light is incident on the photodiode D1, a current (a photocurrent in the photodiode D1) flows from a wire having the potential VC into the accumulation node via the transistor T2, the photodiode D1 and the transistor T3, and charge is added to the accumulation node (FIG. 24 (c)). Accordingly, the potential Vint rises in accordance with an amount of light to be incident while the clock signal CLK is in the LOW level (during a turn-off period of the backlight 3).

In the read period, the clock signal CLK turns to the HIGH level, the clock signals CLKP and CLKQ and the reset signal RST turn to the LOW level, and the read signal RWS turns to a HIGH level for read. Herein, the transistors T1 and T4 turn on, and the transistors T2 and T3 turn off. Herein, the potential Vint rises by an amount which is (Cq/Cp) times (Cp: a capacitance value of the entire pixel circuit 60, Cq: a capacitance value of the capacitor C1) as large as a rise amount of a potential at the read signal RWS. The transistor M1 constitutes a source follower amplification circuit, and drives the output line OUT in accordance with the potential Vint (FIG. 24 (d)).

As described above, the pixel circuit 60 according to this embodiment includes the one photodiode D1 (optical sensor), the one accumulation node which accumulates the charge corresponding to the amount of sensed light, the transistor M1 (read transistor) which has the control terminal connected to the accumulation node, and the transistors T1 to T4 (plurality of switching elements) which turn on or off in accordance with the clock signal CLK and switch the path for the current flowing through the photodiode D1.

The transistor T1 is provided between the reset line RST and one of the ends of the photodiode D1, and turns on when the backlight is turned on. The transistor T2 is provided between the wire applied with the predetermined potential VC and the other end of the photodiode D1, and turns on when the backlight is turned off. The transistor T3 is provided between the accumulation node and one of the ends of the photodiode D1, and turns on when the backlight is turned off. The transistor T4 is provided between the accumulation node and the other end of the photodiode D1, and turns on when the backlight is turned on. Each of the transistors T1 and T3 is the N-type (first conductive type) transistor, and each of the transistors T2 and T4 is the P-type (second conductive type) transistor. The transistors T1 and T2 turn on or off in accordance with the clock signal CLK (first control signal), the transistor T3 turns on or off in accordance with the clock signal CLKQ (second control signal), and the transistor T4 turns on or off in accordance with the clock signal CLKP (third control signal). Each of the clock signals CLKP and CLKQ is the inverted signal of the clock signal CLK, and changes at the timing which is different from that of the clock signal CLK.

When the backlight is turned on, the transistors T1 and T4 turn on, the current path is formed to pass through the optical sensor and the transistors T1 and T4, and the current flows out of the accumulation node. When the backlight is turned off, the transistors T2 and T3 turn on, the current path is formed to pass through the optical sensor and the transistors T2 and T3, and the current flows into the accumulation node. As described above, since the current flows through the accumulation node in reverse direction when the backlight is turned on and when the backlight is turned off, the potential at the accumulation node changes in reverse direction when the backlight is turned on and when the backlight is turned off. According to the pixel circuit 60, hence, it is possible to detect the difference between an amount of light when the backlight is turned on and an amount of light when the backlight is turned off, by use of one sensor pixel circuit.

### SEVENTH EMBODIMENT

FIG. 26 is a circuit diagram of a pixel circuit according to a seventh embodiment of the present invention. A pixel circuit 70 shown in FIG. 26 includes transistors T1 to T4 and M1, a photodiode D1, and a capacitor C1. Each of the transistors T1, T4 and M1 is an N-type TFT, and each of the transistors T2 and T3 is a P-type TFT. The pixel circuit 70 is connected to two clock lines CLK and CLKR.

As shown in FIG. 26, gates of the transistors T1 and T4 are connected to the clock line CLK, and gates of the transistors T2 and T3 are connected to the clock line CLKR. In the transistor T1, a source is connected to a reset line RST, and a drain is connected to an anode of the photodiode D1 and a source of the transistor T3. In the transistor T2, a source is applied with a potential VC, and a drain is connected to a cathode of the photodiode D1 and a source of the transistor T4. Drains of the transistors T3 and T4 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 70, a node connected to the gate of the transistor M1 serves as an accumulation node, and the transistor M1 functions as a read transistor.

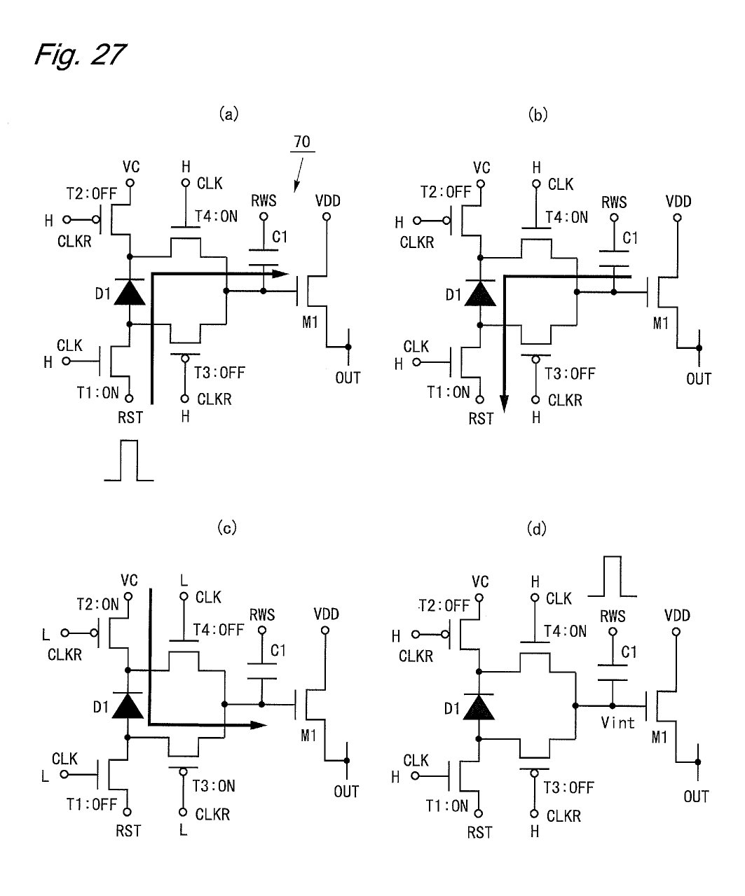

FIG. 27 is a diagram showing operations of the pixel circuit 70. As shown in FIG. 27, the pixel circuit 70 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period.

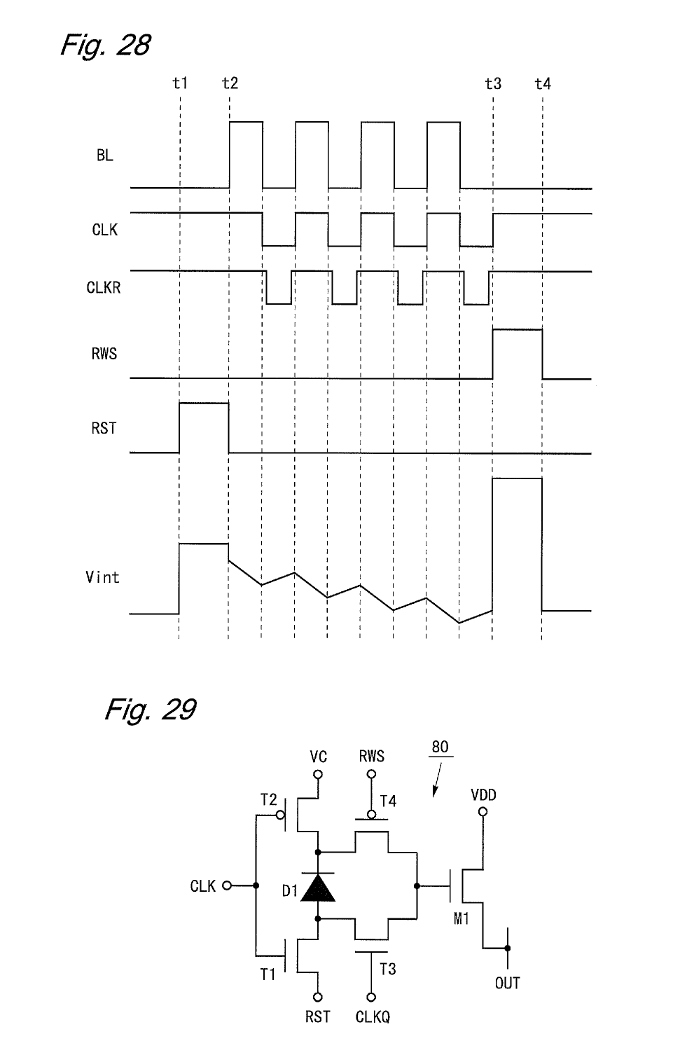

FIG. 28 is a signal waveform diagram of the pixel circuit 70. As shown in FIG. 28, a clock signal CLKR turns on or off as in a clock signal CLK. However, a LOW-level period of the clock signal CLKR is shorter than a half cycle of the clock signal CLK. In FIG. 28, a reset period corresponds to a range from a time t1 to a time t2, an accumulation period corresponds to a range from the time t2 to a time t3, and a read period corresponds to a range from the time t3 to a time t4.

In the reset period, the clock signals CLK and CLKR turn to a HIGH level, the read signal RWS turns to a LOW level, and the reset signal RST turns to a HIGH level for reset. Herein, the transistors T1 and T4 turn on, and the transistors T2 and T3 turn off. Accordingly, a current (a forward current in the photodiode D1) flows from the reset line RST into the accumulation node via the transistor T1, the photodiode D1 and the transistor T4 (FIG. 27 (a)), and a potential Vint is reset to a predetermined level.

In the accumulation period, the reset signal RST and the read signal RWS turn to the LOW level, and the clock signals CLK and CLKR turn to the HIGH level and the LOW level four times, respectively. While the clock signals CLK and CLKR are in the HIGH level, the transistors T1 and T4 turn on, and the transistors T2 and T3 turn off. Herein, when light is incident on the photodiode D1, a current (a photocurrent in the photodiode D1) flows from the accumulation node into the reset line RST via the transistor T4, the photodiode D1 and the transistor T1, and charge is pulled out of the accumulation node (FIG. 27 (b)). Accordingly, the potential Vint drops in accordance with an amount of light to be incident while the clock signal CLK is in the HIGH level (during a turn-on period of the backlight 3).

On the other hand, while the clock signals CLK and CLKR are in the LOW level, the transistors T1 and T4 turn off, and the transistors T2 and T3 turn on. Herein, when light is incident on the photodiode D1, a current (a photocurrent in the photodiode D1) flows from a signal line having the potential VC into the accumulation node via the transistor T2, the photodiode D1 and the transistor T3, and charge is added to the accumulation node (FIG. 27 (c)). Accordingly, the potential Vint rises in accordance with an amount of light to be incident while the clock signal CLK is in the LOW level (during a turn-off period of the backlight 3).

In the read period, the clock signals CLK and CLKR turn to the HIGH level, the reset signal RST turns to the LOW level, and the read signal RWS turns to a HIGH level for read. Herein, the transistors T1 and T4 turn on, and the transistors T2 and T3 turn off. Herein, the potential Vint rises by an amount which is (Cq/Cp) times (Cp: a capacitance value of the entire pixel circuit 70, Cq: a capacitance value of the capacitor C1) as large as a rise amount of a potential at the read signal RWS. The transistor M1 constitutes a source follower amplification circuit, and drives the output line OUT in accordance with the potential Vint (FIG. 27 (d)).

As described above, as in the pixel circuit 60 according to the sixth embodiment, the pixel circuit 70 according to this embodiment includes the one photodiode D1, the one accumulation node, the transistor M1, and the transistors T1 to T4. In the pixel circuit 70, each of the transistors T1 and T4 is the N-type (first conductive type) transistor, and each of the transistors T2 and T3 is the P-type (second conductive type) transistor. The transistors T1 and T4 turn on or off in accordance with the clock signal CLK (first control signal), and transistors T2 and T3 turn on or off in accordance with the clock signal CLKR (second control signal). The clock signal CLKR changes at a different timing in the same direction as the clock signal CLK.

In the pixel circuit 70, as in the pixel circuit 60 according to the sixth embodiment, the current flows into the accumulation node in reverse direction when the backlight is turned on and when the backlight is turned off, and the potential at the accumulation node changes in reverse direction when the backlight is turned on and when the backlight is turned off. According to the pixel circuit 70, hence, it is possible to detect a difference between an amount of light when the backlight is turned on and an amount of light when the backlight is turned off, by use of one sensor pixel circuit. Moreover, by using the two clock signals CLK and CLKR as control signals, it is possible to reduce the number of control signals, to increase an aperture ratio and to enhance the sensitivity of the sensor pixel circuit.

### EIGHTH EMBODIMENT

FIG. 29 is a circuit diagram of a pixel circuit according to an eighth embodiment of the present invention. A pixel circuit 80 shown in FIG. 29 includes transistors T1 to T4 and M1, and a photodiode D1. Each of the transistors T1, T3 and M1 is an N-type TFT, and each of the transistors T2 and T4 is a P-type TFT. The pixel circuit 80 is connected to two clock lines CLK and CLKQ.

As shown in FIG. 29, gates of the transistors T1 and T2 are connected to the clock line CLK, a gate of the transistor T3 is connected to the clock line CLKQ, and a gate of the transistor T4 is connected to a read line RWS. In the transistor T1, a source is connected to a reset line RST, and a drain is connected to an anode of the photodiode D1 and a drain of the transistor T3. In the transistor T2, a source is applied with a potential VC, and a drain is connected to a cathode of the photodiode D1 and a drain of the transistor T4. Sources of the transistors T3 and T4 are connected to a gate of the transistor M1. In the transistor M1, a drain is connected to a power supply line VDD, and a source is connected to an output line OUT. In the pixel circuit 80, a node connected to the gate of the transistor M1 serves as an accumulation node, and the transistor M1 functions as a read transistor. The transistor T4 amplifies a potential at the accumulation node when a gate thereof is applied with a HIGH-level potential for read.

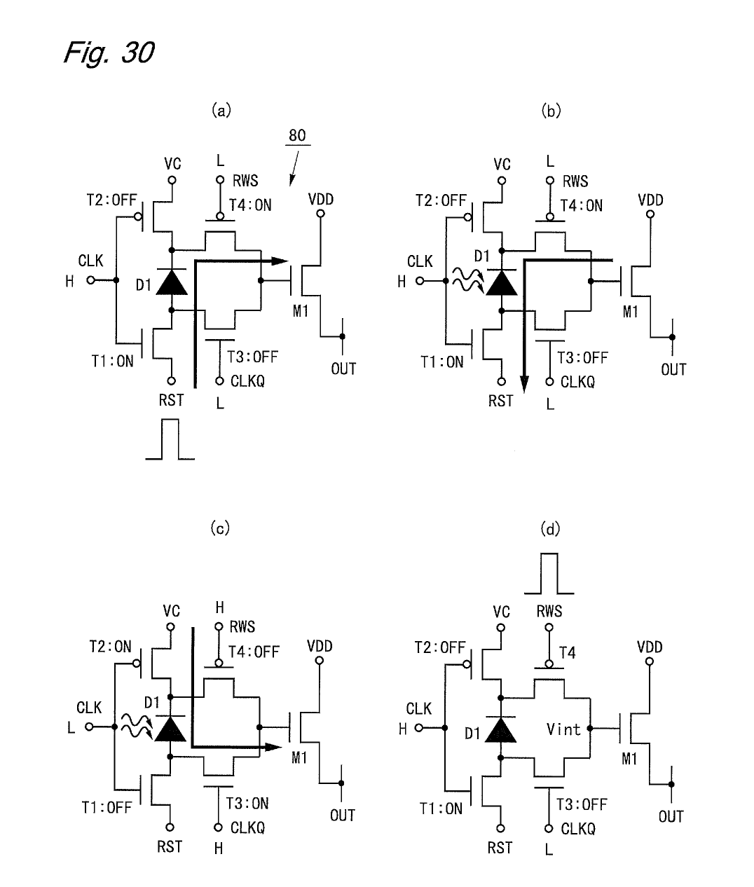

FIG. 30 is a diagram showing operations of the pixel circuit 80. As shown in FIG. 30, the pixel circuit 80 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period.

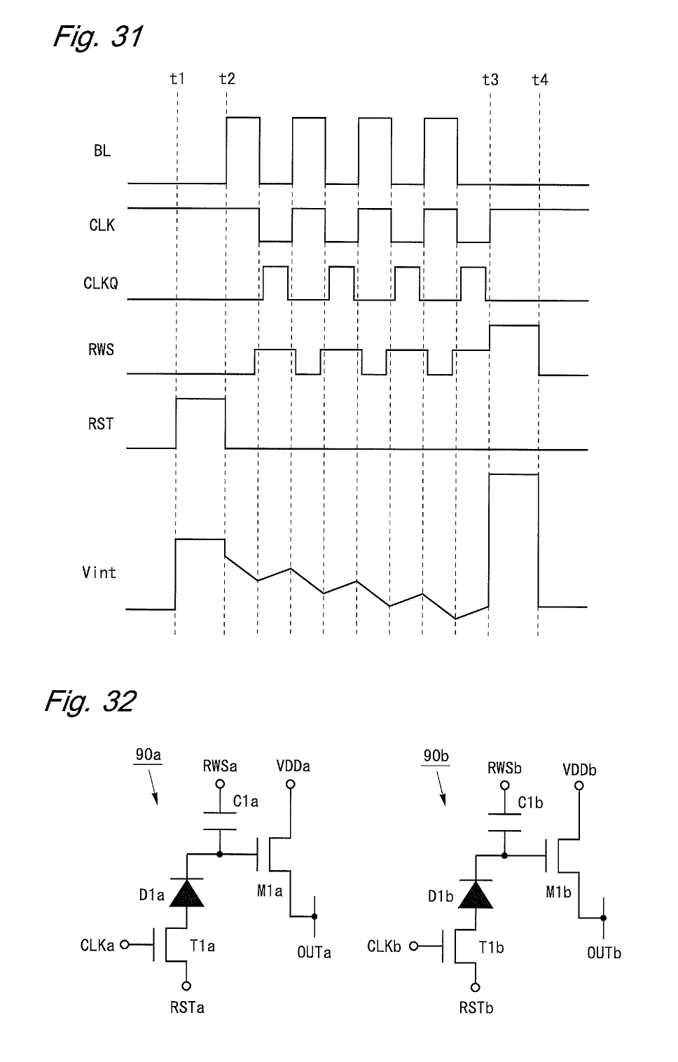

FIG. 31 is a signal waveform diagram of the pixel circuit 80. As shown in FIG. 31, the clock signal CLKQ is an inverted signal of the clock signal CLK. Moreover, in an accumulation period, the read signal RWS is an inverted signal of the clock signal CLK. However, a HIGH-level period of the clock signal CLKQ and a LOW-level period of the read signal RWS in the accumulation period are equal in length to each other, and are shorter than a half cycle of the clock signal CLK. In FIG. 31, a reset period corresponds to a range from a time t1 to a time t2, the accumulation period corresponds to a range from the time t2 to a time t3, and a read period corresponds to a range from the time t3 to a time t4.

In the reset period, the clock signal CLK turns to a HIGH level, the clock signal CLKQ and the read signal RWS turn to a LOW level, and a reset signal RST turns to a HIGH level for reset. Herein, the transistors T1 and T4 turn on, and the transistors T2 and T3 turn off. Accordingly, a current (a forward current in the photodiode D1) flows from the reset line RST into the accumulation node via the transistor T1, the photodiode D1 and the transistor T4 (FIG. 30 (a)), and a potential Vint is reset to a predetermined level.

In the accumulation period, the reset signal RST turns to the LOW level, and the clock signals CLK and CLKQ and the read signal RWS turn to the HIGH level and the LOW level four times, respectively. While the clock signal CLK is in the HIGH level and the clock signal CLKQ and the read signal RWS are in the LOW level, the transistors T1 and T4 turn on, and the transistors T2 and T3 turn off. Herein, when light is incident on the photodiode D1, a current (a photocurrent in the photodiode D1) flows from the accumulation node into the reset line RST via the transistor T4, the photodiode D1 and the transistor T1, and charge is pulled out of the accumulation node (FIG. 30 (b)). Accordingly, the potential Vint drops in accordance with an amount of light to be incident while the clock signal CLK is in the HIGH level (during a turn-on period of the backlight 3).

On the other hand, while the clock signal CLK is in the LOW level and the clock signal CLKQ and the read signal RWS are in the HIGH level, the transistors T1 and T4 turn off, and the transistors T2 and T3 turn on. Herein, when light is incident on the photodiode D1, a current (a photocurrent in the photodiode D1) flows from a signal line having the potential VC into the accumulation node via the transistor T2, the photodiode D1 and the transistor T3, and charge is added to the accumulation node (FIG. 30 (c)). Accordingly, the potential Vint rises in accordance with an amount of light to be incident while the clock signal CLK is in the LOW level (during a turn-off period of the backlight 3).

In the read period, the clock signal CLK turns to the HIGH level, the clock signal CLKQ and reset signal RST turn to the LOW level, and the read signal RWS turns to a HIGH level for read. Herein, the transistors T1 and T4 turn on, and the transistors T2 and T3 turn off. The transistor T4 amplifies the potential Vint when the gate thereof is applied with the HIGH-level potential for read. Accordingly, the potential Vint rises by an amount which is (Cq/Cp) times (Cp: a capacitance value of the entire pixel circuit 80, Cq: a capacitance value of the capacitor C1) as large as a rise amount of a potential at the read signal RWS. The transistor M1 constitutes a source follower amplification circuit, and drives the output line OUT in accordance with the potential Vint (FIG. 30 (d)).

As described above, as in the pixel circuit 60 according to the sixth embodiment, the pixel circuit 80 according to this embodiment includes the one photodiode D1, the one accumulation node, the transistor M1, and the transistors T1 to T4. These constituent elements are equal in characteristics and connection forms to those of the pixel circuit 60 according to the sixth embodiment. According to the pixel circuit 80, hence, it is possible to detect a difference between an amount of light when the backlight is turned on and an amount of light when the backlight is turned off, by use of one sensor pixel circuit. Moreover, in the pixel circuit 80, when the potential for read is applied to the gate of the transistor T4, the potential at the accumulation node (the gate potential at the transistor M1) is amplified. Thus, it is possible to enhance the sensitivity of the sensor pixel circuit.

### NINTH EMBODIMENT

FIG. 32 is a circuit diagram of pixel circuits according to a ninth embodiment of the present invention. As shown in FIG. 32, a first pixel circuit 90a includes transistors T1a and M1a, a photodiode D1a, and a capacitor C1a. A second pixel circuit 90b includes transistors T1b and M1b, a photodiode D1b, and a capacitor C1b. Each of the transistors T1a, M1a, T1b and M1b is an N-type TFT.

With regard to the first pixel circuit 90a, in the transistor T1a, a source is connected to a reset line RSTa, a gate is connected to a clock line CLKa, and a drain is connected to an anode of the photodiode D1a. A cathode of the photodiode D1a is connected to a gate of the transistor M1a. In the transistor M1a, a drain is connected to a power supply line VDDa, and a source is connected to an output line OUTa. The capacitor C1a is provided between the gate of the transistor M1a and a read line RWSa. In the first pixel circuit 90a, a node connected to the gate of the transistor M1a serves as an accumulation node, and the transistor M1a functions as a read transistor. The second pixel circuit 90b has a configuration which is equal to that of the first pixel circuit 90a.

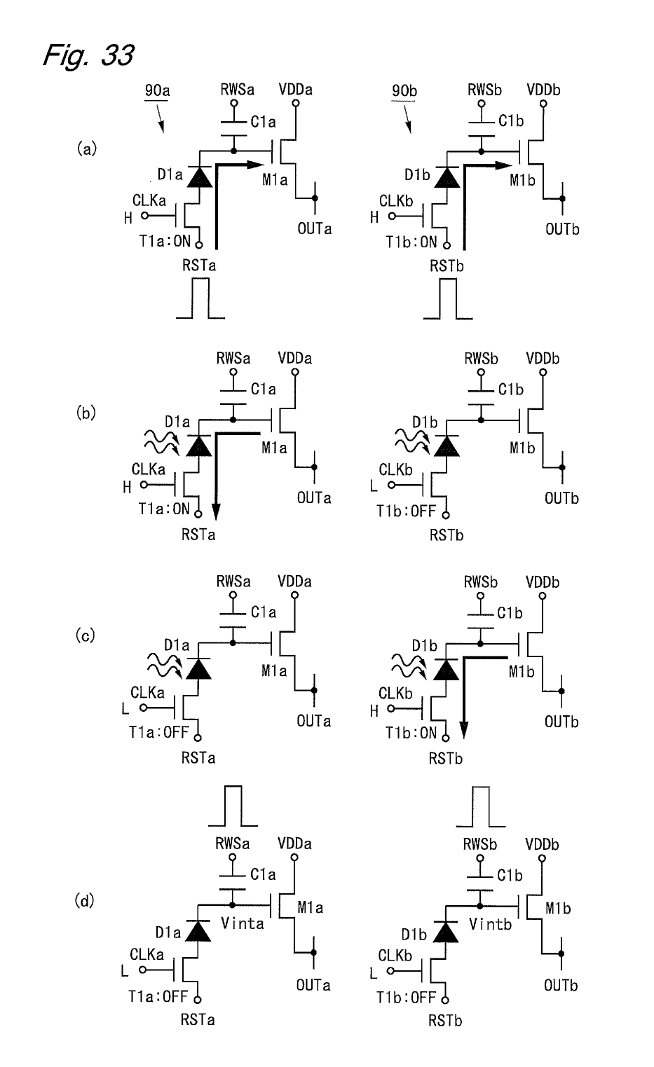

FIG. 33 is a diagram showing operations of the first and second pixel circuits 90a and 90b. As shown in FIG. 33, the first and second pixel circuits 90a and 90b perform (a) reset, (b) accumulation and retention when a backlight is turned on, (c) accumulation and retention when the backlight is turned off, and (d) read, in a one-frame period. The accumulation and retention when the backlight is turned on and the accumulation and retention when the backlight is turned off are performed four times, respectively, in the one-frame period.

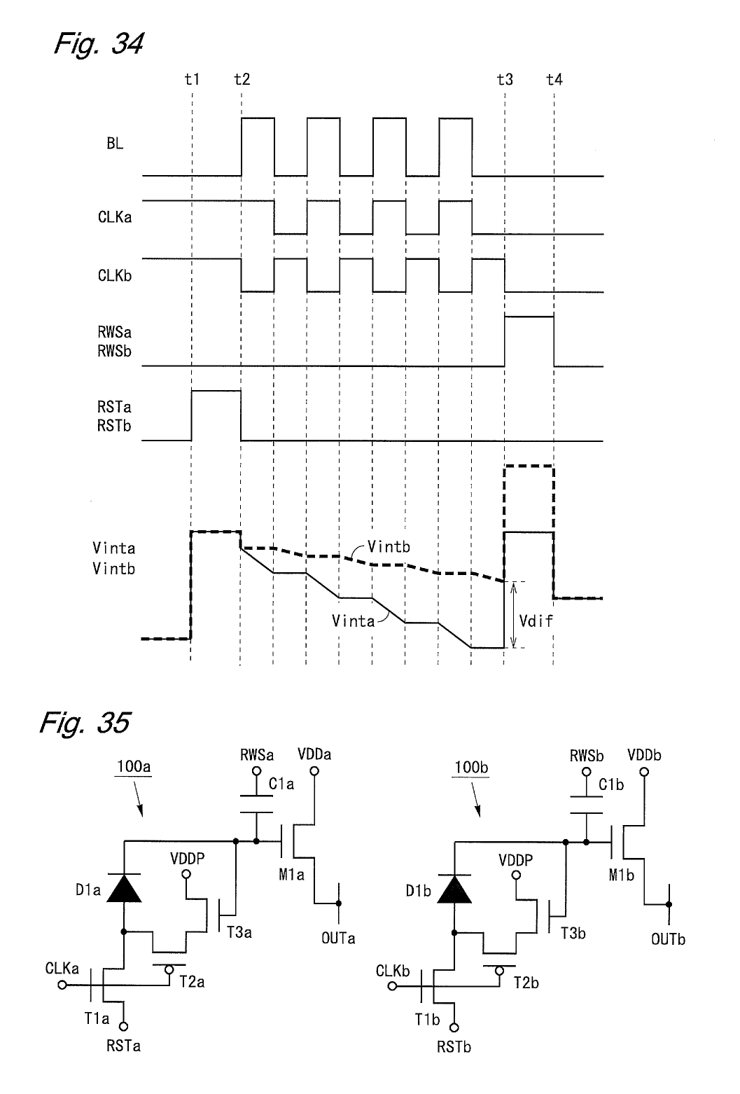

FIG. 34 is a signal waveform diagram of the first and second pixel circuits 90a and 90b. In FIG. 34, Vinta represents a potential at the accumulation node in the first pixel circuit 90a (a gate potential at the transistor M1a), and Vintb represents a potential at the accumulation node in the second pixel circuit 90b (a gate potential at the transistor M1b). In FIG. 34, a reset period corresponds to a range from a time t1 to a time t2, an accumulation and retention period corresponds to a range from the time t2 to a time t3, and a read period corresponds to a range from the time t3 to a time t4.

In the reset period, clock signals CLKa and CLKb turn to a HIGH level, read signals RWSa and RWSb turn to a LOW level, and reset signals RSTa and RSTb turn to a HIGH level for reset. Herein, the transistors T1a and T1b turn on. Accordingly, in the first pixel circuit 90a, a current (a forward current in the photodiode D1a) flows from the reset line RSTa into the accumulation node via the transistor T1a and the photodiode D1a, and in the second pixel circuit 90b, a current (a forward current in the photodiode D1b) flows from the reset line RSTb into the accumulation node via the transistor T1b and the photodiode D1b (FIG. 33 (a)). Thus, the potentials Vinta and Vintb are reset to a predetermined level.

In the accumulation and retention period, the reset signals RSTa and RSTb and the read signals RWSa and RWSb turn to the LOW level, and the clock signals CLKa and CLKb turn to the HIGH level and the LOW level four times, respectively. While the clock signal CLKa is in the HIGH level and the clock signal CLKb is in the LOW level, the transistor T1a turns on and the transistor T1b turns off. Herein, when light is incident on the photodiode D1a, a current (a photocurrent in the photodiode D1a) flows from the accumulation node of the first pixel circuit 90a into the reset line RSTa via the photodiode D1a and the transistor T1a, and charge is pulled out of the accumulation node. Moreover, even when light is incident on the photodiode D1b, a photocurrent in the photodiode D1b does not flow in the second pixel circuit 90b (FIG. 33 (b)). Accordingly, the potential Vinta drops in accordance with an amount of light to be incident during this period (during a turn-on period of the backlight 3), and the potential Vintb does not change.

On the other hand, while the clock signal CLKa is in the LOW level and the clock signal CLKb is in the HIGH level, the transistor T1a turns off and the transistor T1b turns on. Herein, when light is incident on the photodiode D1b, a current (a photocurrent in the photodiode D1b) flows from the accumulation node of the second pixel circuit 90b into the reset line RSTb via the photodiode D1b and the transistor T1b, and charge is pulled out of the accumulation node. Moreover, even when light is incident on the photodiode D1a, a photocurrent in the photodiode D1a does not flow in the first pixel circuit 90a (FIG. 33 (c)). Accordingly, the potential Vintb drops in accordance with an amount of light to be incident during this period (during a turn-off period of the backlight 3), and the potential Vinta does not change.

In the read period, the clock signals CLKa and CLKb and the reset signals RSTa and RSTb turn to the LOW level, and the read signals RWSa and RWSb turn to a HIGH level for read. Herein, the transistors T1a and T1b turn off. Herein, the potential Vinta rises by an amount which is (Cqa/Cpa) times (Cpa: a capacitance value of the entire first pixel circuit 90a, Cqa: a capacitance value of the capacitor C1a) as large as a rise amount of a potential at the read signal RWSa, and the transistor M1a drives the output line OUTa in accordance with the potential Vinta. Likewise, the potential Vintb rises by an amount which is (Cqb/Cpb) times (Cpb: a capacitance value of the entire second pixel circuit 90b, Cqb: a capacitance value of the capacitor C1b) as large as a rise amount of a potential at the read signal RWSb, and the transistor M1b drives the output line OUTb in accordance with the potential Vintb (FIG. 33 (d)).

As described above, the first pixel circuit 90a according to this embodiment includes the one photodiode D1a (optical sensor), the one accumulation node which accumulates the charge corresponding to the amount of sensed light, the transistor M1a (read transistor) which has the control terminal connected to the accumulation node, and the transistor T1a (retention switching element) which is provided on the path for the current flowing through the photodiode D1a and turns on or off in accordance with the clock signal CLK. The photodiode D1a is provided between the accumulation node and one of the ends of the transistor T1a, and the other end of the transistor T1a is connected to the reset line RSTa. The transistor T1a turns on when the backlight is turned on, in accordance with the clock signal CLKa. The second pixel circuit 90b has the configuration which is similar to that of the first pixel circuit 90a, and the transistor T1b included in the second pixel circuit 90b turns on when the backlight is turned off.

As described above, the transistor T1a that turns on when the backlight is turned on is provided on the path for the current flowing through the photodiode D1a, and the transistor T1b that turns on when the backlight is turned off is provided on the path for the current flowing through the photodiode D1b. Thus, it is possible to constitute the first pixel circuit 90a that senses light when the backlight is turned on and retains the amount of sensed light otherwise, and the second pixel circuit 90b that senses light when the backlight is turned off and retains the amount of sensed light otherwise.

### TENTH EMBODIMENT

FIG. 35 is a circuit diagram of pixel circuits according to a tenth embodiment of the present invention. As shown in FIG. 35, a first pixel circuit 100a includes transistors T1a, T2a, T3a and M1a, a photodiode D1a, and a capacitor C1a. A second pixel circuit 100b includes transistors T1b, T2b, T3b and M1b, a photodiode D1b, and a capacitor C1b. Each of the transistors T1a, T3a, M1a, T1b, T3b and M1b is an N-type TFT, and each of the transistors T2a and T2b is a P-type TFT. A HIGH-level potential VDDP is supplied to the first pixel circuit 100a and the second pixel circuit 100b.

With regard to the first pixel circuit 100a, gates of the transistors T1a and T2a are connected to a clock line CLKa. In the transistor T1a, a source is connected to a reset line RSTa and a drain is connected to an anode of the photodiode D1a and a drain of the transistor T2a. A cathode of the photodiode D1a is connected to a gate of the transistor M1a. In the transistor M1a, a drain is connected to a power supply line VDDa, and a source is connected to an output line OUTa. The capacitor C1a is provided between the gate of the transistor M1a and a read line RWSa. In the transistor T3a, a drain is applied with a potential VDDP, a gate is connected to the gate of the transistor M1a, and a source is connected to a source of the transistor T2a. In the first pixel circuit 100a, a node connected to the gate of the transistor M1a serves as an accumulation node, and the transistor M1a functions as a read transistor. The second pixel circuit 100b has a configuration which is equal to that of the first pixel circuit 100a.

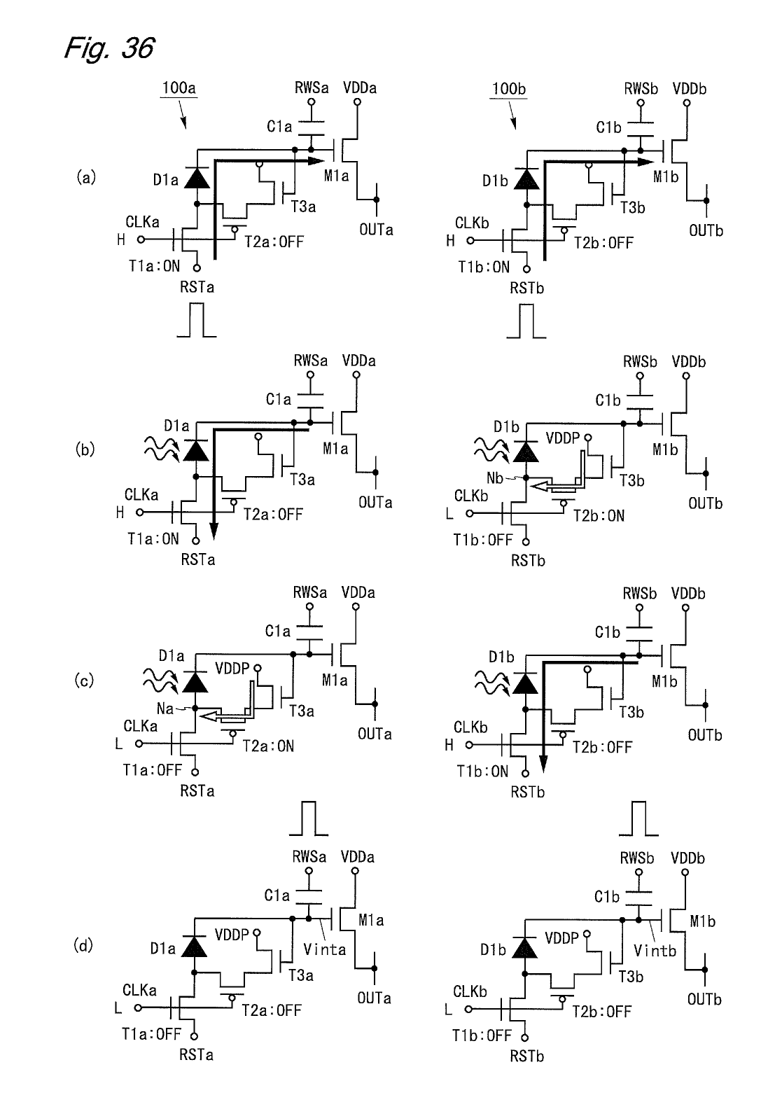

FIG. 36 is a diagram showing operations of the first and second pixel circuits 100a and 100b. As shown in FIG. 36, the first and second pixel circuits 100a and 100b perform (a) reset, (b) accumulation and retention when a backlight is turned on, (c) accumulation and retention when the backlight is turned off, and (d) read, in a one-frame period. The accumulation and retention when the backlight is turned on and the accumulation and retention when the backlight is turned off are performed four times, respectively, in the one-frame period. A signal waveform diagram of the first and second pixel circuits 100a and 100b is equal to that in the ninth embodiment (FIG. 34).

The first and second pixel circuits 100a and 100b operate as in the first and second pixel circuits 90a and 90b according to the ninth embodiment, except for the following points. The transistor T2a turns off when a clock signal CLKa is in a HIGH level, and turns on when the clock signal CLKa is in a LOW level. The transistor T2b turns off when a clock signal CLKb is in the HIGH level, and turns on when the clock signal CLKb is in the LOW level.

In an accumulation and retention period, when the clock signal CLKb changes from the HIGH level to the LOW level, the transistor T2b changes off to on. At this moment, a node Nb connected to an anode of the photodiode D1b is charged with a potential corresponding to a gate potential Vintb at the transistor M1b, via the transistors T2b and T3b (a white arrow in FIG. 36 (b)). Therefore, upon change from the time when the backlight is turned off to the time when the backlight is turned on, a current flowing through the photodiode D1b is interrupted immediately.

On the other hand, in the accumulation and retention period, when the clock signal CLKa changes from the HIGH level to the LOW level, the transistor T2a changes off to on. At this moment, a node Na connected to the anode of the photodiode D1a is charged with a potential corresponding to a gate potential Vinta at the transistor M1a, via the transistors T2a and T3a (a white arrow in FIG. 36 (c)). Therefore, upon change from the time when the backlight is turned on to the time when the backlight is turned off, a current flowing through the photodiode D1a is interrupted immediately.

As described above, the first pixel circuit 100a according to this embodiment corresponds to the first pixel circuit 90a according to the ninth embodiment additionally including the transistor T2a (first switching element) which has one of the ends connected to the anode (transistor T1a-side terminal) of the photodiode D1a and turns on or off in accordance with the clock signal CLKa, and the transistor T3a (second switching element) which feeds the potential corresponding to the potential at the accumulation node to the source of the transistor T2a. The transistor T2a turns on when the backlight is turned off. The second pixel circuit 100b has the configuration which is similar to that of the first pixel circuit 100a, and the transistor T2b included in the second pixel circuit 100b turns on when the backlight is turned on.

According to the first and second pixel circuits 100a and 100b, as in the first and second pixel circuits 90a and 90b according to the ninth embodiment, it is possible to detect an amount of light when the backlight is turned on and an amount of light when the backlight is turned off. Moreover, by applying the potential corresponding to the potential at the accumulation node to the terminal, which is opposed to the accumulation node, of the photodiode D1a upon change of the clock signal CLKa, it is possible to immediately interrupt the current flowing through the photodiode D1a, and to enhance detection accuracy. With regard to the second pixel circuit 100b, it is possible to attain similar effects.

### ELEVENTH EMBODIMENT

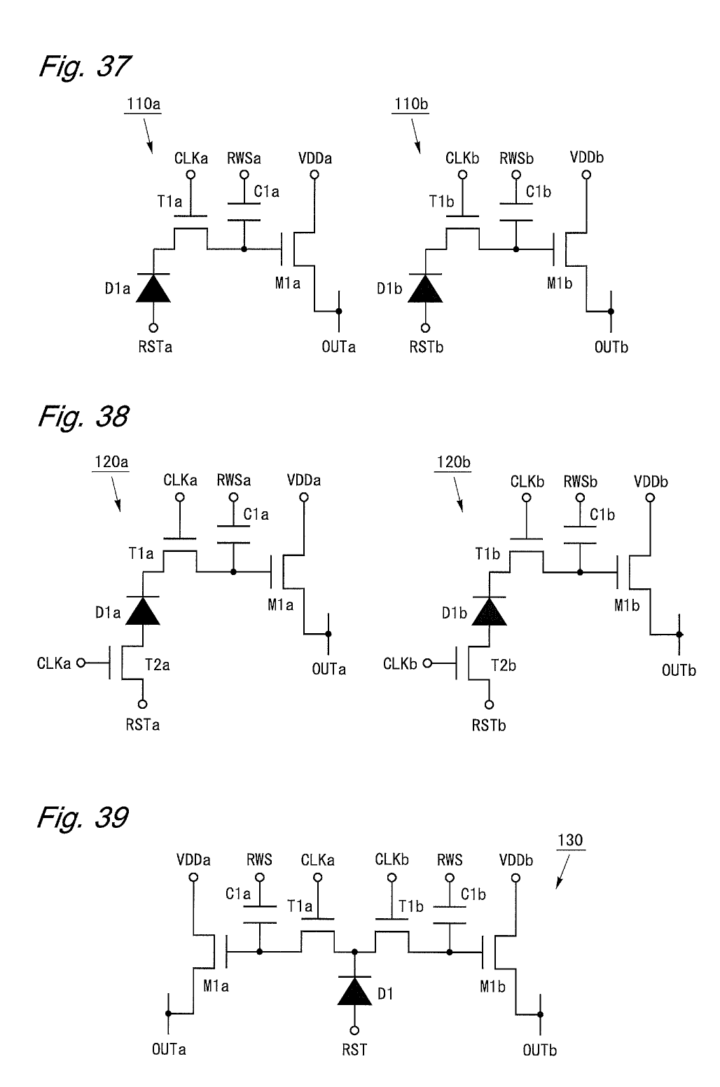

FIG. 37 is a circuit diagram of pixel circuits according to an eleventh embodiment of the present invention. As shown in FIG. 37, a first pixel circuit 110a includes transistors T1a and M1a, a photodiode D1a, and a capacitor C1a. A second pixel circuit 110b includes transistors T1b and M1b, a photodiode D1b, and a capacitor C1b. Each of the transistors T1a, M1a, T1b and M1b is an N-type TFT.

With regard to the first pixel circuit 110a, in the photodiode D1a, an anode is connected to a reset line RSTa, and a cathode is connected to a source of the transistor T1a. In the transistor T1a, a gate is connected to a clock line CLKa, and a drain is connected to a gate of the transistor M1a. In the transistor M1a, a drain is connected to a power supply line VDDa, and a source is connected to an output line OUTa. The capacitor C1a is provided between the gate of the transistor M1a and a read line RWSa. In the first pixel circuit 110a, a node connected to the gate of the transistor M1a serves as an accumulation node that accumulates charge corresponding to an amount of sensed light, and the transistor M1a functions as a read transistor. The second pixel circuit 110b has a configuration which is equal to that of the first pixel circuit 110a. The first pixel circuit 110a operates as in the first pixel circuit 90a according to the ninth embodiment. Similar things hold true for the second pixel circuit 110b.

As described above, the first pixel circuit 110a according to this embodiment includes the constituent elements which are equal to those of the first pixel circuit 90a according to the ninth embodiment. However, in the first pixel circuit 110a, the transistor T1a is provided between the accumulation node and one of the ends of the photodiode D1a, and the other end of the photodiode D1a is connected to a reset line RSTa. The transistor T1a turns on when a backlight is turned on, in accordance with a clock signal CLKa. The second pixel circuit 110b has the configuration which is similar to that of the first pixel circuit 110a, and the transistor T1b included in the second pixel circuit 110b turns on when the backlight is turned off.

As described above, the transistor T1a that turns on when the backlight is turned on is provided on a path for a current flowing through the photodiode D1a, and the transistor T1b that turns on when the backlight is turned off is provided on a path for a current flowing through the photodiode D1b. Thus, it is possible to constitute the first pixel circuit 110a that senses light when the backlight is turned on and retains the amount of sensed light otherwise, and the second pixel circuit 110b that senses light when the backlight is turned off and retains the amount of sensed light otherwise.

### TWELFTH EMBODIMENT

FIG. 38 is a circuit diagram of pixel circuits according to a twelfth embodiment of the present invention. As shown in FIG. 38, a first pixel circuit 120a includes transistors T1a, T2a and M1a, a photodiode D1a, and a capacitor C1a. A second pixel circuit 120b includes transistors T1b, T2b and M1b, a photodiode D1b, and a capacitor C1b. Each of the transistors T1a, T2a, M1a, T1b, T2b and M1b is an N-type TFT.

With regard to the first pixel circuit 120a, gates of the transistors T1a and T2a are connected to a clock line CLKa. In the transistor T2a, a source is connected to a reset line RSTa, and a drain is connected to an anode of the photodiode D1a. A cathode of the photodiode D1a is connected to a source of the transistor T1a. A drain of the transistor T1a is connected to a gate of the transistor M1a. In the transistor M1a, a drain is connected to a power supply line VDDa, and a source is connected to an output line OUTa. The capacitor C1a is provided between the gate of the transistor M1a and a read line RWSa. In the first pixel circuit 120a, a node connected to the gate of the transistor M1a serves as an accumulation node, and the transistor M1a functions as a read transistor. The second pixel circuit 120b has a configuration which is equal to that of the first pixel circuit 120a. The first pixel circuit 120a operates as in the first pixel circuit 110a according to the eleventh embodiment, except that the transistor T2a turns on or off at a timing which is equal to that of the transistor T1a. Similar things hold true for the second pixel circuit 120b.

As described above, the first pixel circuit 120a according to this embodiment includes the one photodiode D1a (optical sensor), the one accumulation node which accumulates charge corresponding to an amount of sensed light, the transistor M1a (read transistor) which has the control terminal connected to the accumulation node, and the transistors T1a and T2a (two retention switching elements). The transistor T1a is provided between the accumulation node and one of the ends of the photodiode D1a, and the transistor T2a is provided between the reset line RSTa and the other end of the photodiode D1a. The transistors T1a and T2a turn on when the backlight is turned on, in accordance with a clock signal CLKa. The second pixel circuit 120b has the configuration which is similar to that of the first pixel circuit 120a, and the transistors T1b and T2b included in the second pixel circuit 120b turn on when the backlight is turned off.

As described above, the transistors T1a and T2a that turn on when the backlight is turned on are provided on the two sides of the photodiode D1a, and the transistors T1b and T2b that turn on when the backlight is turned off are provided on the two sides of the photodiode D1b. Thus, it is possible to constitute the first pixel circuit 120a that senses light when the backlight is turned on and retains the amount of sensed light otherwise and the second pixel circuit 120b that senses light when the backlight is turned off and retains the amount of sensed light otherwise.

Moreover, in the first pixel circuit 120a, the transistor T2a provided between the photodiode D1a and the reset line RSTa turns off when the backlight is turned off. Therefore, it becomes possible to reduce a variation in a cathode potential at the photodiode D1a because of a current flowing through the photodiode D1a, and to reduce a difference between potentials to be applied to the two ends of the transistor T1a. Thus, it is possible to reduce a leakage current flowing through the transistor T1a, to prevent a variation of a potential at the accumulation node, and to enhance detection accuracy. Also in the second pixel circuit 120b, it is possible to attain similar effects.

### THIRTEENTH EMBODIMENT

FIG. 39 is a circuit diagram of a pixel circuit according to a thirteenth embodiment of the present invention. A pixel circuit 130 shown in FIG. 39 includes transistors T1a, T1b, M1a and M1b, a photodiode D1, and capacitors C1a and C1b. Each of the transistors T1a, T1b, M1a and M1b is an N-type TFT. In FIG. 39, the left half corresponds to a first pixel circuit and the right half corresponds to a second pixel circuit. The pixel circuit 130 is connected to clock lines CLKa and CLKb, a reset line RST, a read line RWS, power supply lines VDDa and VDDb, and output lines OUTa and OUTb.

As shown in FIG. 39, in the photodiode D1, an anode is connected to the reset line RST, and a cathode is connected to sources of the transistors T1a and T1b. In the transistor T1a, a gate is connected to the clock line CLKa, and a drain is connected to a gate of the transistor M1a. In the transistor M1a, a drain is connected to the power supply line VDDa, and a source is connected to the output line OUTa. The capacitor C1a is provided between the gate of the transistor M1a and the read line RWS. In the transistor T1b, a gate is connected to the clock line CLKb, and a drain is connected to a gate of the transistor M1b. In the transistor M1b, a drain is connected to the power supply line VDDb, and a source is connected to the output line OUTb. The capacitor C1b is provided between the gate of the transistor M1b and the read line RWS. In the pixel circuit 130, a node connected to the gate of the transistor M1a serves as a first accumulation node, a node connected to the gate of the transistor M1b serves as a second accumulation node, and each of the transistors M1a and M1b functions as a read transistor.

As described above, the pixel circuit 130 according to this embodiment has the configuration that the first and second pixel circuits 110a and 110b according to the eleventh embodiment share the one photodiode D1 (optical sensor). In the shared photodiode D1, the cathode is connected to the source of the transistor T1a included in the section corresponding to the first pixel circuit and the source of the transistor T1b included in the section corresponding to the second pixel circuit. The pixel circuit 130 configured as described above operates as in the first and second pixel circuits 110a and 110b according to the eleventh embodiment.

According to the pixel circuit 130, as in the first and second pixel circuits 110a and 110b according to the eleventh embodiment, it is possible to detect an amount of light when the backlight is turned on and an amount of light when the backlight is turned off. Moreover, by causing the pixel circuits of two types share the one photodiode D1, it is possible to cancel an influence of a variation in sensitivity characteristics of the photodiode, and to accurately obtain a difference between the amount of light when the backlight is turned on and the amount of light when the backlight is turned off. Moreover, it is possible to reduce the number of photodiodes, to increase the aperture ratio, and to enhance the sensitivity of the sensor pixel circuit.

### FOURTEENTH EMBODIMENT

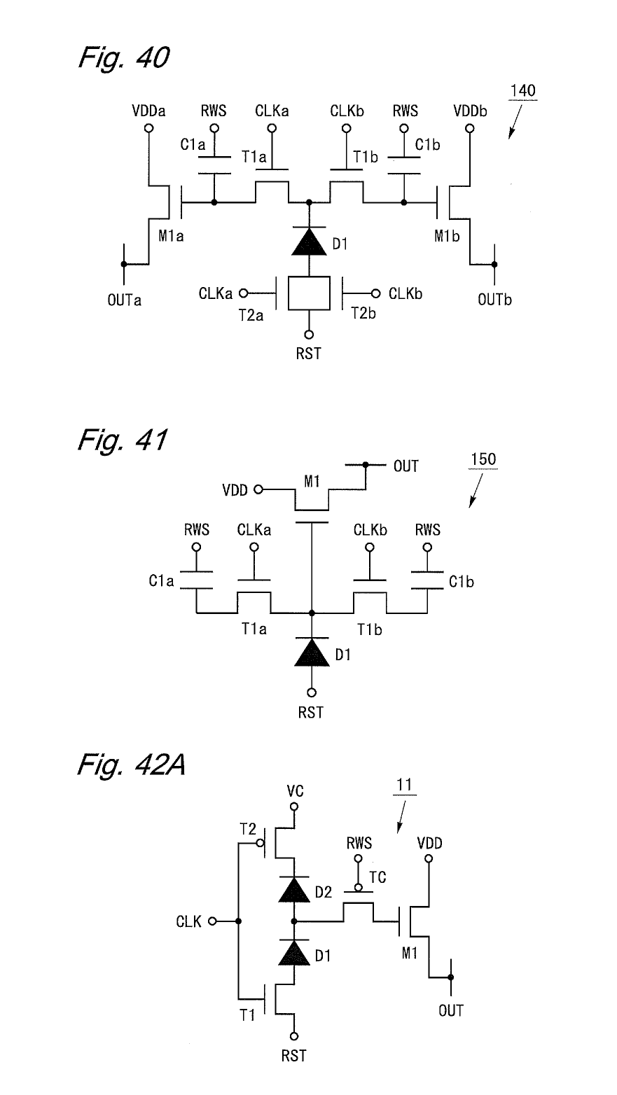

FIG. 40 is a circuit diagram of a pixel circuit according to a fourteenth embodiment of the present invention. A pixel circuit 140 shown in FIG. 40 includes transistors T1a, T1b, T2a, T2a, M1a and M1b, a photodiode D1, and capacitors C1a and C1b. Each of the transistors T1a, T1b, T2a, T2b, M1a and M1b is an N-type TFT. In FIG. 40, the left half corresponds to a first pixel circuit and the right half corresponds to a second pixel circuit. The pixel circuit 140 is connected to clock lines CLKa and CLKb, a reset line RST, a read line RWS, power supply lines VDDa and VDDb, and output lines OUTa and OUTb.

As shown in FIG. 40, gates of the transistors T1a and T2a are connected to the clock line CLKa, and gates of the transistors T2a and T2b are connected to the clock line CLKb. In the transistors T2a and T2b, sources are connected to the reset line RST and drains are connected to an anode of the photodiode D1. A cathode of the photodiode D1 is connected to sources of the transistors T1a and T1b. In the transistor T1a, the gate is connected to the clock line CLKa, and a drain is connected to a gate of the transistor M1a. In the transistor M1a, a drain is connected to the power supply line VDDa, and a source is connected to the output line OUTa. The capacitor C1a is provided between the gate of the transistor M1a and the read line RWS. In the transistor T1b, a gate is connected to the clock line CLKb, and a drain is connected to a gate of the transistor M1b. In the transistor M1b, a drain is connected to the power supply line VDDb, and a source is connected to the output line OUTb. The capacitor C1b is provided between the gate of the transistor M1b and the read line RWS. In the pixel circuit 140, a node connected to the gate of the transistor M1a serves as a first accumulation node, a node connected to the gate of the transistor M1b serves as a second accumulation node, and each of the transistors M1a and M1b functions as a read transistor.

As described above, the pixel circuit 140 according to this embodiment has the configuration that the first and second pixel circuits 120a and 120b according to the twelfth embodiment share the one photodiode D1 (optical sensor). In the shared photodiode D1, the cathode is connected to the source of the transistor T1a included in the section corresponding to the first pixel circuit and the source of the transistor T1b included in the section corresponding to the second pixel circuit. The anode of the photodiode D1 is connected to the drain of the transistor T2a included in the section corresponding to the first pixel circuit and the drain of the transistor T2b included in the section corresponding to the second sensor pixel circuit. The pixel circuit 140 operates as in the first and second pixel circuits 120a and 120b according to the twelfth embodiment.

According to the pixel circuit 140, as in the first and second pixel circuits 120a and 120b according to the twelfth embodiment, it is possible to detect an amount of light when a backlight is turned on and an amount of light when the backlight is turned off. Moreover, as in the twelfth embodiment, it is possible to reduce leakage currents flowing through the transistors T1a and T1b, to prevent variations of potentials at the first and second accumulation nodes, and to enhance the detection accuracy. Moreover, by causing the pixel circuits of two types share the one photodiode D1, it is possible to cancel an influence of a variation in sensitivity characteristics of the photodiode, and to accurately obtain a difference between the amount of light when the backlight is turned on and the amount of light when the backlight is turned off. Moreover, it is possible to reduce the number of photodiodes, to increase an aperture ratio, and to enhance the sensitivity of the sensor pixel circuit.

### FIFTEENTH EMBODIMENT

FIG. 41 is a circuit diagram of a pixel circuit according to a fifteenth embodiment of the present invention. A pixel circuit 150 shown in FIG. 41 includes transistors T1a, T1b and M1, a photodiode D1, and capacitors C1a and C1b. Each of the transistors T1a, T1b and M1 is an N-type TFT. In FIG. 41, the left half corresponds to a first pixel circuit and the right half corresponds to a second pixel circuit. The pixel circuit 150 is connected to clock lines CLKa and CLKb, a reset line RST, a read line RWS, a power supply line VDD, and an output line OUT.

As shown in FIG. 41, in the photodiode D1, an anode is connected to the reset line RST, and a cathode is connected to sources of the transistors T1a and T1b and a gate of the transistor M1. A gate of the transistor T1a is connected to the clock line CLKa, and a gate of the transistor T1b is connected to the clock line CLKb. The capacitor C1a is provided between a drain of the transistor T1a and the read line RWS. The capacitor C1b is provided between a drain of the transistor T1b and the read line RWS. In the transistor M1, a drain is connected to the power supply line VDD, and a source is connected to the output line OUT. In the pixel circuit 150, a node connected to the drain of the transistor T1a serves as a first accumulation node, a node connected to the drain of the transistor T1b serves as a second accumulation node, and the transistor M1 functions as a read transistor.

As described above, the pixel circuit 150 according to this embodiment has the configuration that the first and second pixel circuits 110a and 110b according to the eleventh embodiment share the photodiode D1 and the transistor M1 (read transistor). The gate (control terminal) of the shared transistor M1 is connected to one of the ends of the shared photodiode D1, one of the ends of the transistor T1a included in the section corresponding to the first pixel circuit, and one of the ends of the transistor T1b included in the section corresponding to the second pixel circuit. As described above, the gate of the transistor M1 is configured to be electrically connectable to the first and second accumulation nodes via the transistors T1a and T1b. The pixel circuit 150 operates as in the first and second pixel circuits 110a and 110b according to the eleventh embodiment.

According to the pixel circuit 150, as in the pixel circuit 130 according to the thirteenth embodiment, it is possible to detect an amount of light when a backlight is turned on and an amount of light when the backlight is turned off. Moreover, by causing the pixel circuits of two types share the one photodiode D1, it is possible to attain effects which are similar to those of the thirteenth embodiment. Moreover, by causing the pixel circuits of two types share the transistor M1, it is possible to cancel an influence of a variation in threshold value characteristics of the transistor M1, and to accurately obtain a difference between the amount of light when the backlight is turned on and the amount of light when the backlight is turned off.

(Modification Examples of Embodiments)

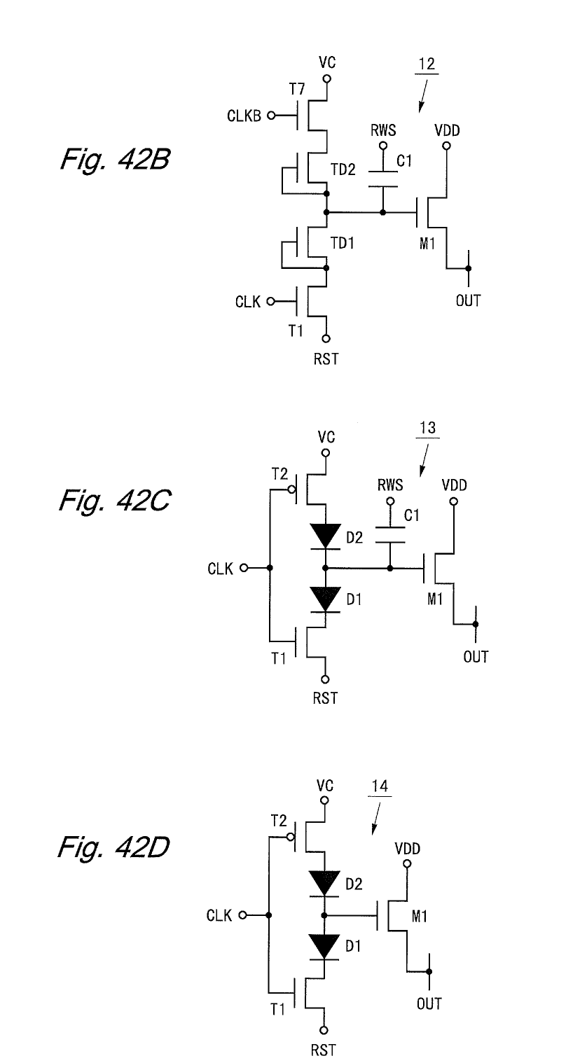

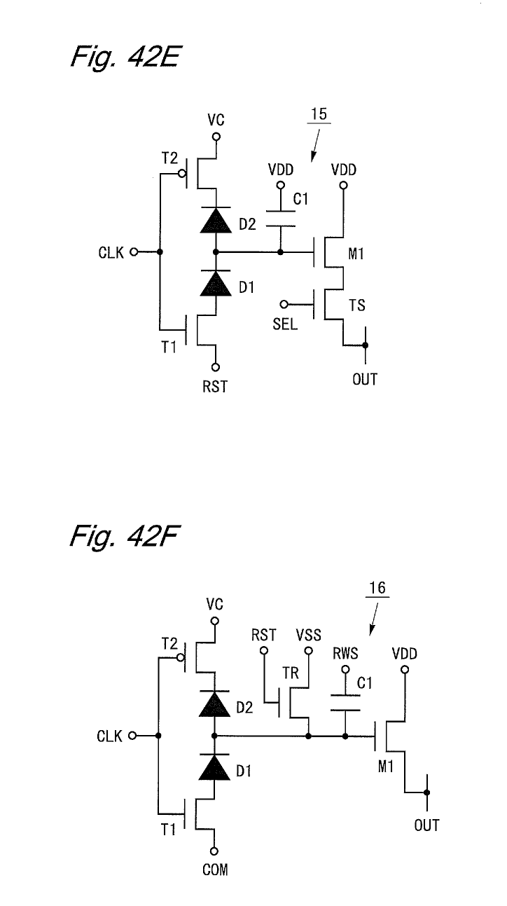

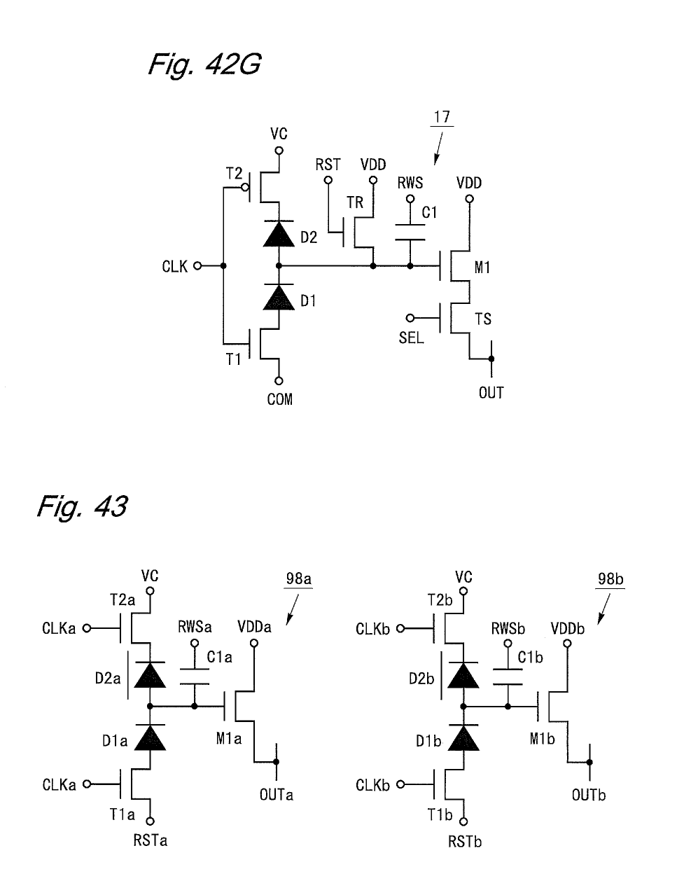

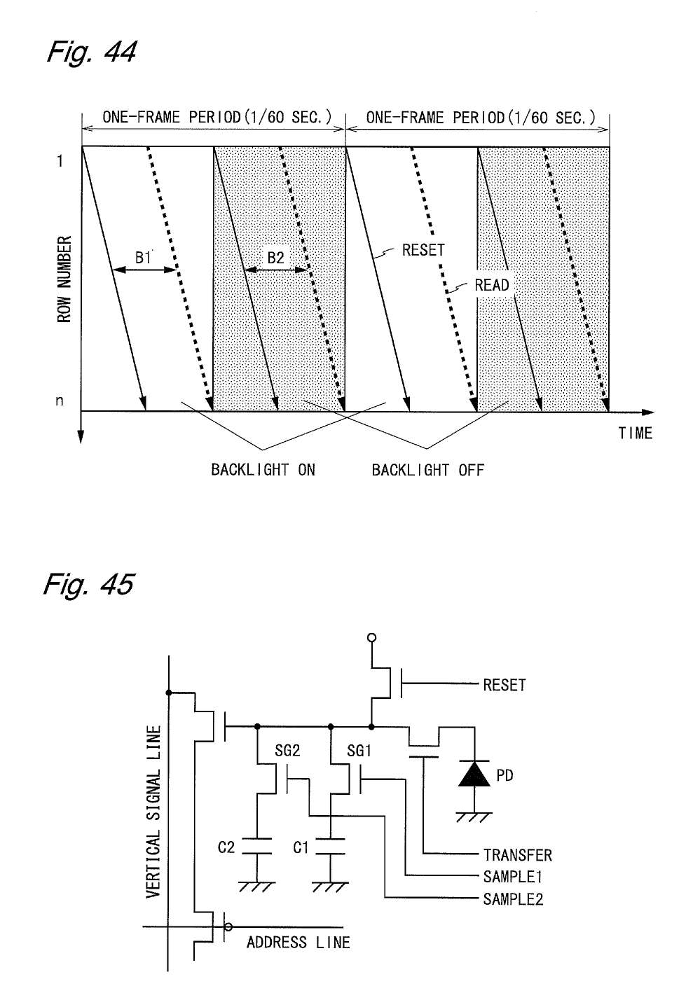

The respective embodiments of the present invention may employ the following modification examples. FIGS. 42A to 42G are circuit diagrams of pixel circuits according to first to seventh modification examples of the first embodiment. Pixel circuits 11 to 17 shown in FIGS. 42A to 42G are achieved in such a manner that the pixel circuit 10 according to the first embodiment is subjected to the following modifications.

The pixel circuit 11 shown in FIG. 42A corresponds to the pixel circuit 10 in which the capacitor C1 is substituted with a transistor TC which is a P-type TFT. With regard to the pixel circuit 11, in the transistor TC, one of conductive terminals is connected to a cathode of a photodiode D1 and an anode of a photodiode D2, the other conductive terminal is connected to a gate of a transistor M1, and a gate is connected to a read line RWS. When a HIGH level for read is applied to the read line RWS, the transistor TC having the connection form described above causes a larger change in a potential at an accumulation node, as compared with the original pixel circuit. Accordingly, it is possible to amplify a difference between a potential at the accumulation node in the case where incident light is strong and a potential at the accumulation node in the case where incident light is weak, and to improve the sensitivity of the pixel circuit 11.

The pixel circuit 12 shown in FIG. 42B corresponds to the pixel circuit 10 in which the photodiodes D1 and D2 are substituted with phototransistors TD1 and TD2 and the transistor T2 is substituted with a transistor T7 which is an N-type TFT. With regard to the pixel circuit 12, in the transistor T7, a drain is applied with a potential VC, a source is connected to a cathode of the phototransistor TD2, and a gate is connected to a clock line CLKB for propagating an inverted signal of a clock signal CLK. Thus, all the transistors included in the pixel circuit 12 are of an N-type. Accordingly, it is possible to manufacture the pixel circuit 12 by use of a single channel process capable of manufacturing only N-type transistors. It is to be noted that in the case of carrying out this modification, all the P-type transistors included in the pixel circuit need to be substituted with N-type transistors.

The pixel circuit 13 shown in FIG. 42C corresponds to the pixel circuit 10 in which the photodiodes D1 and D2 are connected in reverse. The pixel circuit 13 is supplied with a reset signal RST which is in a HIGH level in a normal condition and turns to a LOW level for reset at the time of reset, and a LOW-level potential VC which is lower than a LOW-level potential for reset. A drain of a transistor T1 is connected to a reset line RST, and a source of the transistor T1 is connected to a cathode of the photodiode D1. In a transistor T2, a drain is applied with a potential VC, and a source is connected to an anode of the photodiode D2. An anode of the photodiode D1 and a cathode of the photodiode D2 are connected to a gate of a transistor M1. Thus, it is possible to achieve a variety of pixel circuits.

The pixel circuit 14 shown in FIG. 42D corresponds to the pixel circuit 10 in which the photodiodes D1 and D2 are connected in reverse and from which the capacitor C1 is removed. The pixel circuit 14 is supplied with a reset signal RST and a potential VC as in the pixel circuit 13. However, the reset signal RST turns to a HIGH level for read at the time of read. When the reset signal RST turns to the HIGH level for read, a potential at the accumulation node (a gate potential at a transistor M1) rises, and a current corresponding to a potential at the accumulation node flows into the transistor M1. As described above, the pixel circuit 14 does not include the capacitor C1. Accordingly, it is possible to increase an aperture ratio by virtue of the removal of the capacitor C1, and to improve the sensitivity of the pixel circuit.

The pixel circuit 15 shown in FIG. 42E corresponds to the pixel circuit 10 to which a transistor TS is added. The transistor TS is an N-type TFT, and functions as a switching element for selection. With regard to the pixel circuit 15, in a capacitor C1, one of electrodes is applied with a HIGH-level potential VDD. A source of a transistor M1 is connected to a drain of the transistor TS. In the transistor TS, a source is connected to an output line OUT, and a gate is connected to a selection line SEL. A selection signal SEL turns to a HIGH level at the time of read from the pixel circuit 15. Thus, it is possible to achieve a variety of pixel circuits.

The pixel circuit 16 shown in FIG. 42F corresponds to the pixel circuit 10 to which a transistor TR is added. The transistor TR is an N-type TFT, and functions as a switching element for reset. With regard to the pixel circuit 16, in the transistor TR, a source is applied with a LOW-level potential VSS, a drain is connected to a gate of a transistor M1, and a gate is connected to a reset line RST. Moreover, a source of the transistor T1 is applied with a LOW-level potential COM. Thus, it is possible to achieve a variety of pixel circuits. It is to be noted that the pixel circuit provided with the transistor TR functioning as a switching element for reset may be further provided with a transistor TS functioning as a switching element for selection.

The pixel circuit 17 shown in FIG. 42G corresponds to the pixel circuit 10 to which the transistors TS and TR described above are added. Connection forms of the transistors TS and TR are equal to those in the pixel circuits 15 and 16. However, with regard to the pixel circuit 17, the drain of the transistor TR is applied with a HIGH-level potential VDD. Thus, it is possible to achieve a variety of pixel circuits.

The first pixel circuit 98a shown in FIG. 43 corresponds to the first pixel circuit 90a according to the ninth embodiment to which a photodiode D2a is added. The photodiode D2a is shielded from light, and functions as an optical sensor for reference. In the photodiode D2a, an anode is connected to a cathode of a photodiode D1a and a source of a transistor T1a, and a cathode is applied with a predetermined potential VC. The potential VC is a potential which is higher than a HIGH-level potential for reset. It is possible to perform temperature compensation for a photodiode since a dark current flows through the photodiode D2a.

Similar modifications can be carried out on the second to fifteenth embodiments. Moreover, the first to fifteenth embodiments may employ various modification examples in such a manner that the modifications described above are combined arbitrarily without violating their properties.

As described above, in the display devices according to the embodiments of the present invention and the modification examples of the embodiments, the plurality of sensor pixel circuits for detecting a difference between an amount of light to be incident when the backlight is turned on and an amount of light to be incident when the backlight is turned off (alternatively, sensor pixel circuits of two types for detecting an amount of light to be incident when the backlight is turned on and an amount of light to be incident when the backlight is turned off separately) are arranged in the pixel region. The backlight is turned on and off a plurality of times, respectively, in a one-frame period. Reset for the sensor pixel circuits and read from the sensor pixel circuits are performed in parallel, each in a line sequential manner over almost the one-frame period. Thus, it is possible to detect the difference between the amount of light to be incident when the backlight is turned on and the amount of light to be incident when the backlight is turned off. Therefore, it is possible to solve the conventional problems and to give an input function which does not depend on light environments.

It is to be noted that the type of the light source to be provided on the display device is not particularly limited in the present invention. Accordingly, for example, a visible light backlight to be provided for display may be turned on and off a plurality of times, respectively, in a one-frame period. Alternatively, an infrared light backlight for light sensing may be provided separately from the visible light backlight for display on the display device. In such a display device, the visible light backlight may always be turned, and only the infrared light backlight may be turned on and off a plurality of times, respectively, in the one-frame period.

### INDUSTRIAL APPLICABILITY

The display device according to the present invention is characterized by having an input function which does not depend on light environments, and therefore is applicable to various display devices in which a plurality of optical sensors are provided on a display panel.

### EXPLANATION OF REFERENCE SYMBOLS

1: Display control circuit
2: Display panel
3: Backlight
4: Pixel region
5: Gate driver circuit
6: Source driver circuit
7: Sensor row driver circuit
8: Display pixel circuit
9: Sensor pixel circuit
10 to 17, 20, 30, 40, 48, 50, 58, 60, 70, 80, 90, 98, 100, 110, 120, 130, 140, 150: Pixel circuit

1. A display device in which a plurality of optical sensors are arranged in a pixel region, the display device comprising:
a display panel that includes a plurality of display pixel circuits and a plurality of sensor pixel circuits;
a light source that is turned on and off a plurality of times, respectively, in a one-frame period; and
a drive circuit that outputs, to the sensor pixel circuits, a control signal indicating that a light source is turned on or the light source is turned off, and performs reset for and read from the sensor pixel circuits, wherein
the sensor pixel circuit performs an operation for detecting a difference between an amount of light when the light source is turned on and an amount of light when the light source is turned off, in accordance with the control signal, and
the drive circuit performs the reset for the sensor pixel circuits and the read from the sensor pixel circuits in parallel, each in a line sequential manner.

2. The display device according to claim 1, wherein
the drive circuit performs the reset for the sensor pixel circuits and the read from the sensor pixel circuits once, respectively, in the one-frame period over almost the one-frame period.

3. The display device according to claim 2, wherein
the drive circuit performs the read from the sensor pixel circuits on one row, and then immediately performs the reset for the sensor pixel circuits on the row.

4. The display device according to claim 3, wherein
a turn-on period of the light source is equal in length to a turn-off period of the light source.

5. The display device according to claim 1, wherein
the sensor pixel circuit includes:
a first optical sensor;
a second optical sensor;
one accumulation node accumulating charge corresponding to an amount of sensed light; and
a read transistor having a control terminal connected to the accumulation node, and
the sensor pixel circuit is configured so that, in accordance with the control signal, a potential at the accumulation node is changed in a predetermined direction by a current flowing through the first optical sensor when the light source is turned on and is changed in the reverse direction by a current flowing through the second optical sensor when the light source is turned off.

6. The display device according to claim 5, wherein
the sensor pixel circuit further includes:
a first switching element that is provided on a path for the current flowing through the first optical sensor and turns on, in accordance with the control signal, when the light source is turned on; and
a second switching element that is provided on a path for the current flowing through the second optical sensor and turns on, in accordance with the control signal, when the light source is turned off.

7. The display device according to claim 5, wherein
the first and second optical sensors have sensitivity characteristics that, in accordance with the control signal, the current flowing through the first optical sensor becomes larger in amount than the current flowing through the second optical sensor when the light source is turned on, and the current flowing through the second optical sensor becomes larger in amount than the current flowing through the first optical sensor when the light source is turned off.

8. The display device according to claim 1, wherein
the sensor pixel circuit includes:
one optical sensor;
one accumulation node accumulating charge corresponding to an amount of sensed light;
a read transistor having a control terminal connected to the accumulation node; and
a plurality of switching elements that turn on or off in accordance with the control signal and switch a path for a current flowing through the optical sensor, and
the sensor pixel circuit is configured so that, in accordance with the control signal, the current flowing through the optical sensor flows in a predetermined direction with respect to the accumulation node when the light source is turned on, and flows in the reverse direction with respect to the accumulation node when the light source is turned off.

9. The display device according to claim 8, wherein
the sensor pixel circuit includes:
a first switching element that is provided between a reset line and one of ends of the optical sensor and turns on when the light source is turned on;
a second switching element that is provided between a wire applied with a predetermined potential and the other end of the optical sensor and turns on when the light source is turned off;
a third switching element that is provided between the accumulation node and the one of ends of the optical sensor and turns on when the light source is turned off; and
a fourth switching element that is provided between the accumulation node and the other end of the optical sensor and turns on when the light source is turned on.

10. The display device according to claim 1, wherein
the sensor pixel circuits include:
a first sensor pixel circuit that senses light when the light source is turned on and retains the amount of sensed light otherwise, in accordance with the control signal; and
a second sensor pixel circuit that senses light when the light source is turned off and retains the amount of sensed light otherwise, in accordance with the control signal.

11. The display device according to claim 10, wherein
each of the first and second sensor pixel circuits includes:
one optical sensor;
one accumulation node accumulating charge corresponding to the amount of sensed light;
a read transistor having a control terminal being electrically connectable to the accumulation node; and
a retention switching element that is provided on a path for a current flowing through the optical sensor and turns on or off in accordance with the control signal,
the retention switching element included in the first sensor pixel circuit turns on when the light source is turned on, and
the retention switching element included in the second sensor pixel circuit turns on when the light source is turned off.

12. The display device according to claim 10, wherein
the display panel further includes a plurality of output lines for propagating output signals from the first and second sensor pixel circuits,
the first and second sensor pixel circuits are connected to the different output lines depending on the type, and
the drive circuit performs the read from the first and second sensor pixel circuits in parallel.

13. The display device according to claim 12, further comprising a difference circuit that obtains a difference between the output signal from the first sensor pixel circuit and the output signal from the second sensor pixel circuit.

14. A method for driving a display device having a display panel that includes a plurality of display pixel circuits and a plurality of sensor pixel circuits, and a light source, the method comprising the steps of:
turning the light source on and off a plurality of times, respectively, in a one-frame period;
outputting, to the sensor pixel circuits, a control signal indicating that the light source is turned on or the light source is turned off;
performing an operation for detecting a difference between an amount of light when the light source is turned on and an amount of light when the light source is turned off, in accordance with the control signal, by use of the sensor pixel circuits;
performing reset for the sensor pixel circuits in a line sequential manner; and
performing read from the sensor pixel circuits in a line sequential manner in parallel to the reset.
